(19) United States
(12) Patent Application Publication
(10) Pub. No.: US 2010/0220078 A1
(43) Pub. Date: Sep. 2, 2010

(54) DIGITAL PEN SYSTEM, TRANSMITTER DEVICES, RECEIVING DEVICES, AND METHODS OF MANUFACTURING AND USING THE SAME

(75) Inventors: Isaac Zloter, Holon (IL); Gideon Shenholz, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: PEGASUS TECHNOLOGIES LTD., Azoor (IL)

(21) Appl. No.: 12/444,393

(22) PCT Filed: Oct. 7, 2007
(86) PCT No.: PCT/IL07/01205

§ 371 Date: Apr. 5, 2009

Related U.S. Application Data
(60) Provisional application No. 60/828,240, filed on Oct. 5, 2006.

(51) Int. Cl. G06F 3/043

(52) U.S. Cl. 345/177

(57) ABSTRACT

A system 5 for tracking the position of a digital 100 pen including a (i) pen-fixed ultrasound device 210 (i.e. transmitter or receiver) and (ii) a plurality of writing-surface fixed ultrasound devices 150 (i.e. transmitters or receivers) is disclosed. In some embodiments, a measurement is made of the time that it takes for ultra-sound to travel between the pen-fixed ultrasound device 210 and the writing-surface fixed ultrasound devices 150 via a path that includes a writing surface sub-path 170 between the ‘given point’ 175 on the writing surface and the writing-surface fixed ultrasound devices 150. In some embodiments, the position of the digital pen 100 or a component thereof (for example, pen-fixed ultrasound device 210) may be determined in accordance with (i) the aforementioned measured times of ultra-sound travel; and (ii) the speed of sound within the writing surface 140. Related methods for tracking the position of the digital pen 100 are disclosed. Related methods for manufacturing any presently-disclosed system are also provided. Furthermore, apparatus and methods for transmitting ultra-sound from a pen-fixed ultrasound transmitter 210, and for detecting ultra-sound that propagates in a board or writing surface 140 are disclosed.

### BACKGROUND OF THE INVENTION

Digital writing instruments (or styluses), interchangeably referred to herein as “digital pens” regardless of whether or not they write in ink, can be used to capture pen strokes and digitize them. Some digital writing systems including optical character recognition (OCR) software for converting recorded pen strokes to text data.

Typically, digital pens operate with and send data to a host device (any computerized platform device such as a “dedicated box”, a personal computer, a PDA, etc.). This may be directly or via one or more receiving stations which receive a signal from the digital pen. The location of the digital pen is tracked with a device tracking mechanism, and location data may be written into memory (volatile and/or non-volatile memory) of the host device. It is noted that systems including digital pens and host devices typically include a communications link (wired or wireless) between the digital pen and the host device.

Certain digital writing systems provide two modes of operations—“digital pen mode” for tracking pen strokes, and a “mouse mode” where the digital pen may serve as a mouse for the host device. In many applications, the pen or stylus (i.e. having a point) is used by the user to ‘write’ or perform strokes on a given surface. Thus, when the stylus or pen is “down” (i.e. contacting the surface), the location of the pen at any given moment may be tracked in order to perform pen strokes. When the pen is “up” (i.e. hovering over the surface) the location of the pen may be tracked in order to provide the “mouse mode,” or, alternatively, can be in “idle” status. Other applications of the “pen hovering” are also known. Typically, when the pen is ‘hovering’ the tip of the pen is less than 2-3 cm from the writing surface, though this is not a limitation, and there may be hovering at more than 2-3 cm. In many systems, the host device is associated with a display, and pen strokes and/or mouse movements may be displayed on the display.

### SUMMARY OF THE INVENTION

A system for tracking the position of a digital pen including a (i) pen-fixed ultrasound device (i.e. transmitter or receiver) and (ii) a plurality of writing-surface fixed ultrasound devices (i.e. transmitters or receivers) is disclosed. In some embodiments, a measurement is made of the time that it takes for ultra-sound to travel between the pen-fixed ultrasound device and the writing-surface fixed ultrasound devices via a path that includes a writing surface sub-path between the ‘given point’ on the writing surface and the writing-surface fixed ultrasound devices. In some embodiments, the position of the digital pen or a component thereof may be determined in accordance with (i) the aforementioned measured times of ultra-sound travel; and (ii) the speed of sound within the writing surface. Related methods for tracking the position of the digital pen are disclosed. Related methods for manufacturing any presently-disclosed system are also provided. Furthermore, apparatus and methods for transmitting ultra-sound from a pen-fixed ultrasound transmitter, and for detecting ultra-sound that propagates in a board or writing surface are disclosed.

It is now disclosed for the first time a contact-mode measuring system comprising: a) a digital pen including a pen housing having a tip and a pen-fixed ultrasound device (i.e. whose position is fixed relative to the pen housing—for example, within the pen housing or attached to the pen house) selected from the group consisting of an ultrasound transmitter and an ultrasound receiver; b) a writing surface; c) a plurality of writing-surface-fixed ultrasound devices, each said ultrasound device selected from the group consisting of an ultrasound transmitter and an ultrasound receiver, each writing-surface-fixed ultrasound device having a respective position that is fixed relative to said writing surface; d) an ultra-sound propagation time measurement system operative, when said digital pen is located on said writing surface, to measure for said each writing-surface-fixed ultrasound device, a respective time that it takes for ultrasound to travel, through said writing surface, between: (i) said pen-fixed ultrasound device; and (ii) said each writing-surface-fixed ultrasound device, via a path that includes a respective writing subpath defined by a path between: (i) a location that is substantially a contact location between said tip and said writing surface within a tolerance that is less than 30% a distance between said contact location and a closest said writing-surface fixed ultrasound device; and (ii) said each writing-surface-fixed device; and e) an ultra-sound based position-determining system for determining a position of said pen-fixed ultrasound device n accordance with: i) said determined ultra-sound travel times; and ii) a speed of sound within said writing surface.

It is now disclosed for the first time a contact or hovering mode position measuring system comprising: a) a digital pen including a pen housing having a tip and a pen-fixed ultrasound device selected from the group consisting of an ultrasound transmitter and an ultrasound receiver; b) a writing surface; c) a plurality of writing-surface-fixed ultrasound devices, each said ultrasound device selected from the group consisting of an ultrasound transmitter and an ultrasound receiver, each writing-surface-fixed ultrasound device having a respective position that is fixed relative to said writing surface; d) an ultra-sound propagation time measurement system operative, when said digital pen is located on or over said writing surface, to measure for said each writing-surface-fixed ultrasound device, a respective time that it takes for ultrasound to travel, through said writing surface, between: (i) said pen-fixed ultrasound device; and (ii) said each writing-surface-fixed ultrasound device, via a path that includes a respective writing surface subpath defined by a path between: (i) an intersection point between elongate axis of said ultrasound device and said writing surface within a tolerance that is less than 30% a distance between said tip and a closest said writing-surface fixed ultrasound device; and (ii) said each writing-surface-fixed device; e) an ultra-sound based position-determining system for determining a position of said pen-fixed ultrasound device in accordance with: i) said determined ultra-sound travel times; and ii) a speed of sound within said writing surface.

It is now disclosed for the first time a contact or hovering mode position measuring system comprising: a) a digital pen including a pen housing having a tip and a pen-fixed ultrasound device selected from the group consisting of an ultrasound transmitter and an ultrasound receiver; b) a writing surface; c) a plurality of writing-surface-fixed ultrasound devices, each said ultrasound device selected from the group consisting of an ultrasound transmitter and an ultrasound receiver, each writing-surface-fixed ultrasound device having a respective position that is fixed relative to said writing surface; d) an ultra-sound propagation time measurement system operative, when said digital pen is located on or over said writing surface, to measure for said each writing-surface-fixed ultrasound device, a respective time that it takes for ultrasound to travel, through said writing surface, between: (i) said pen-fixed ultrasound device; and (ii) said each writing-surface-fixed ultrasound device, via a path that includes a respective writing surface subpath defined by a path between: (i) a given point on said writing surface; and (ii) said each writing-surface-fixed device; e) an ultra-sound based position-determining system for determining a position of said pen-fixed ultrasound device in accordance with: i) said determined ultra-sound travel times; and ii) a speed of sound within said writing surface, wherein, for each said writing surface subpath a ratio between a length of an above-surface sub-path between: (i) said pen-fixed ultrasound device; and (ii) said given point, and a length of said each writing surface subpath is at least 0.1 and at most 10.

It is now disclosed for the first time a comprising: a) a digital pen including a pen housing having a tip and a pen-fixed ultrasound device selected from the group consisting of an ultrasound transmitter and an ultrasound receiver; b) a writing surface; c) a plurality of writing-surface-fixed ultrasound devices, each said ultrasound device selected from the group consisting of an ultrasound transmitter and an ultrasound receiver, each writing-surface-fixed ultrasound device having a respective position that is fixed relative to said writing surface; d) an ultra-sound propagation time measurement system operative, when said digital pen is located on or over said writing surface, to measure for said each writing-surface-fixed ultrasound device, a respective time that it takes for ultrasound to travel, through said writing surface, between: (i) said pen-fixed ultrasound device; and (ii) said each writing-surface-fixed ultrasound device, via a path that includes a respective writing surface subpath selected from the group consisting of: A) a first respective writing surface subpath defined by a path between: I) a given point whose distance from, an intersection point between elongate axis of said ultrasound receiver and said writing surface, is less than 30% a distance between said tip and a closest said writing-surface fixed ultrasound device; and II) said each writing-surface-fixed device; B) a second respective writing surface subpath defined by a path between: I) a location that is substantially a contact location between said tip and said writing surface within a tolerance that is less than 30% a distance between said contact location and a closest said writing-surface fixed ultrasound device; and II) said each writing-surface-fixed device; and e) an ultra-sound based position-determining system for determining a position of pen-fixed ultrasound device in accordance with: i) said determined ultra-sound travel times; and ii) a speed of sound within said writing surface.

In some preferred embodiments, any aforementioned “30% tolerance” for either the contact point between the pen tip and the writing surface or the “intersection point” between the elongate axis of the pen-fixed ultrasound device and the surface is another tolerance—for example, 50% tolerance, 10% tolerance, 5% tolerance and 1% tolerance.

According to some embodiments, each said writing surface subpath a ratio between a length of an above-surface sub-path between: i) said pen-fixed ultrasound device; and (ii) said given point, and a length of said each writing surface subpath is at least 0.1 and at most 10.

According to some embodiments, in said writing surface is transparent.

According to some embodiments, said writing surface is flexible.

According to some embodiments, said writing surface is flexible.

According to some embodiments, said writing surface is constructed of at least one of wood, metal and transparent plastic.

According to some embodiments, the system further comprises: e) a hover-detection element operative to determine if said digital pen is in contact with said writing surface or hovering above said writing surface in accordance with a magnitude of detected sound signals between said pen-fixed ultrasound transceiver and at least one said writing-surface-fixed ultrasound transceiver.

According to some embodiments, the system further comprises: f) a pen-stroke-capturing element operative to capture pen strokes in accordance with changes of position of said digital pen as determined by said ultra-sound based position-determining system; and g) a pen-stroke-processing element operative to handle said captured pen strokes in a manner that is contingent on said digital pen being in said contact with said writing surface, as determined by said hover-detection element.

According to some embodiments, said pen-stroke-processing element is operative to provide a digital writing only for pen-strokes detected when, according to said hover-detection element, said digital pen is in contact with said writing surface.

According to some embodiments, said pen-fixed ultrasound device is an ultrasound transmitter.

According to some embodiments, for a sub-section that is at least 20% of a length of said writing surface subpath, said writing surface subpath is substantially parallel to a local upper surface of said writing surface within a tolerance that is at most 20 degrees.

According to some embodiments, said sub-section is at least 50% of a length of said writing surface subpath.

According to some embodiments, said writing surface includes an edge having a jagged section wherein: i) the length of said jagged section is at least 0.2 times the longest dimension of said writing surface; ii) said jagged edge includes at least n peaks and n−1 troughs, n being defined as an integer that is at least 5; iii) for adjacent peaks over said edge, a distance between adjacent peaks is between at least 0.01 and at most 0.1 times said longest dimension of said writing surface; and iv) for each peak, a peak-to-adjacent trough distance is at least 0.001 and at most 0.03 times said longest dimension of said writing surface.

According to some embodiments, said writing surface includes an edge having a jagged section wherein: i) the length of said jagged section is at least 0.2 times the longest dimension of said writing surface; ii) said jagged edge includes at least n peaks and n−1 troughs, n being defined as an integer that is at least 5; iii) for adjacent peaks over said edge, a distance between adjacent peaks is between at 0.5 and 5 times an ultrasound wavelength of ultrasound produced by an ultrasound transmitter of one of said pen-fixed ultrasound device and said writing-surface fixed ultrasound device; iv) for each peak, a peak-to-adjacent trough distance is at 0.5 and 5 time said ultrasound wavelength.

According to some embodiments, wherein: i) said writing surface is configured such that, when ultrasound propagates over a distance of 5 times, an ultrasound wavelength of ultrasound produced by an ultrasound transmitter of one of said pen-fixed ultrasound device and said writing-surface fixed ultrasound device, an amplitude of said propagating ultrasound is reduced by at most 30% (in some preferred embodiments, at most 20% or at most 10%); and ii) said writing surface includes an edge having a jagged section such that at a distance of (or in some preferred embodiments, a distance of 7 times or 10 times) times said ultrasound wavelength from said jagged section, an amplitude of ultrasound waves reflected from said jagged section is at most 50% of an amplitude of ultrasound wave incident to said jagged section.

This may be due, for example, to damping and/or phase cancellation of ultrasound waves.

In some embodiments, the system further comprises: f) a wired connection between said pen-fixed ultrasound transceiver and each said writing-surface-fixed ultrasound transceiver for ultra-sound signal synchronization, wherein said ultra-sound propagation time measurement system is operative to measure said sound travel times in accordance with said wired-connection-provided signal synchronization.

In some embodiments, said ultra-sound based position-determining is operative when there is no line of site between said pen-fixed ultrasound transceiver and at least one said writing-surface-fixed ultrasound transceiver.

In some embodiments, i) said digital pen further includes an optical transmitter operative to transmit light downwards; ii) the system further includes a writing surface fixed optical receiver; and iii) said writing surface is configured as a waveguide to substantially control a direction of propagation of light such that said propagating light is forced to follow a path that is substantially, within a tolerance of at most 10 degrees, parallel to a plane defined by an upper surface of writing surface for a distance that is at least 20% a distance between optical transmitter and optical receiver.

It is now disclosed for the first time an electronic pen device comprising: a) an elongated housing including an elongated inner cavity and a tip; and b) an ultrasound transmitter for generating ultrasound waves, comprising a piezoelectric film cylinder deployed within said elongated inner cavity such that an elongate axis of said piezoelectric film cylinder is substantially parallel to an elongate axis of said elongated inner cavity within a tolerance that is at most 45 degrees (or at most 22.5 degrees or at most 10 degrees in some preferred embodiments).

According to some embodiments, said elongated housing and said ultrasound transmitter are configured such that, for a transmission axis defined by a line parallel to said elongate axis of said piezoelectric film cylinder through said tip, at least one quarter of power of said generated ultrasound waves crosses a base circle defined by an intersection between: i) a plane perpendicular to said transmission axis; and ii) a body-fixed cone whose apex is said tip, whose theta angle is at most 45 degrees, whose axis is said transmission axis, and whose height is given by 5 times a wavelength of said generated ultrasound.

According to some embodiments, at least a majority of said power of said generated ultrasound waves crosses said base circle.

According to some embodiments, said theta angle is at most 22.5 degrees.

According to some embodiments, said theta angle is at most 10 degrees.

According to some embodiments, said elongated housing and said ultrasound transmitter are configured such that, for a transmission axis defined by a line parallel to said elongate axis of said piezoelectric film cylinder through said tip, at least one majority of power of said generated ultrasound waves crosses a base circle defined by an intersection between: i) a plane perpendicular to said transmission axis; and ii) a body-fixed cone whose apex is said tip, whose theta angle is at most 45 degrees, whose axis is said transmission axis, and whose height is given by 5 times a wavelength of said generated ultrasound.

According to some embodiments, at least a majority of said power of said generated ultrasound waves crosses said base circle.

According to some embodiments, said theta angle is at most 22.5 degrees (or at most 10 degrees in some preferred embodiments).

In some embodiments, the system further comprises: c) at least one ultrasound reflector deployed above said piezoelectric film cylinder within said elongated inner cavity for reflecting upwardly propagating sound generated by said ultrasound transmitter relative to a body-fixed axis of the pen device in a downwards direction, said at least one ultrasound reflector operative to downwardly reflect at least a 25% by ultrasound power upwardly propagating, relative to said body-fixed axis, said ultrasound generated by ultrasound transmitter.

In some embodiments, said at least one ultrasound reflector is configured to downwardly reflect at least a majority by ultrasound power of said upwardly propagating ultrasound.

In some embodiments, said at least one ultrasound reflector is configured to downwardly reflect at least a significant majority by ultrasound power of said upwardly propagating ultrasound comprising at least 75% of said upwardly propagating ultrasound.

In some embodiments, the pen further comprises: c) an ultrasound resonator deployed below, relative to a body fixed axis of the pen device, said piezoelectric film cylinder such that at least 50% of said generated (i.e. by power) ultrasound enters said ultrasound resonator, said ultrasound resonator operative to provide at least a 25% amplitude boost for said generated ultrasound that enters said ultrasound resonator.

In some embodiments, said ultrasound resonator is operative to provide at least a 50% said amplitude boost.

In some embodiments, said ultrasound resonator is operative to provide at least a % said amplitude boost.

In some embodiments, said piezoelectric film cylinder of said ultrasound transmitter comprises at least 5 turns of piezoelectric film.

It is now disclosed for the first time a system for handling ultrasound signals, the system comprising: a) a thin writing surface having a thickness that is at most 0.05 times a longest dimension of said writing surface; and b) an ultrasound receiver comprising a piezoelectric film cylinder fixed relative to said writing surface, at least a contacting portion of said piezoelectric film cylinder deployed in contact with said side surface of said thin writing surface, at least an upper portion of said piezoelectric film cylinder deployed above an upper surface of said writing surface, at least a lower portion of said piezoelectric film deployed below a lower surface of said writing surface, said ultrasound receiver configured to receive ultrasound signals that propagate within said writing surface.

In some embodiments, said ultrasound receiver is configured to receive ultrasound signals that propagate within said writing surface substantially parallely to said upper surface at a contact region: within a tolerance of 22.5 degrees.

In some embodiments, said ultrasound receiver is configured to receive ultrasound signals that propagate within said writing surface substantially parallely to said upper surface at a contact region: within a tolerance of 5 degrees.

In some embodiments, said thickness that is at most 0.01 times a longest dimension of said writing surface.

In some embodiments, said thickness that is at most 0.005 times a longest dimension of said writing surface.

In some embodiments, at least one of (or both of): i) a height of said upper portion above said upper surface; ii) a negative height of said lower portion below said lower surface, is at most 5 times said thickness.

Different embodiments of the invention provide methods for carrying out any technique (for example, for determining a location of a pen-fixed ultrasound device, for measuring the time of propagation of ultrasound signals between a pen-fixed ultra-sound device and a writing surface-fixed ultrasound device, for transmitting ultrasound from a pen-fixed ultra-sound device to a writing surface-fixed ultrasound device, for detecting ultrasound signals that propagate within a writing surface or board).

Related methods for manufacturing any presently-disclosed system are also provided.

These and further embodiments will be apparent from the detailed description and examples that follow.

### BRIEF DESCRIPTION OF THE DRAWINGS

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to’), rather than the mandatory sense (i.e. meaning “must”).

FIG. 1A provides an illustration of a system including a digital pen, a writing surface, and ultrasound and optical receivers whose positions are fixed relative to the wiring surface, in accordance with some embodiments of the present invention.

FIGS. 1B-1E provide illustrations of various configurations including pen-fixed and writing board-fixed ultrasound devices (i.e. both transmitters and receivers) and optical devices (i.e. both transmitters and receivers).

FIG. 1F describes an embodiment where the digital pen is “hovering over” the writing surface.

FIG. 1G describes an embodiment where the digital pen is “on” the writing surface.

FIG. 1H describes inaccuracies in locating pen position when the pen is over the writing surface.

FIGS. 1I-1K describe systems for determining pen position.

FIGS. 1L-1M describe systems for determining pen position and for detecting and pen hovering.

FIGS. 1N-1Q illustrate side views of configurations of the optical transmitter and the optical receiver.

FIG. 2 is an illustration of an exemplary digital pen that includes a pen-fixed ultra-sound transmitter.

FIGS. 3A-3B provide additional views of the pen-fixed ultrasound transmitter.

FIGS. 3C-3D illustrate a geometric construct useful for describing substantially uni-directional ultrasound transmission.

FIG. 4 provides an illustration of a writing surface or board with an edge for damping echoes of ultrasound waves propogating along the surface of the writing surface or board.

FIG. 5A provides a diagram of an embodiment where the receiver is located near but not at the edge of the board or writing surface.

FIG. 5B provides a diagram of an embodiment where the receiver is mechanically supported by a optional separate support element. FIG. 6A present an illustration of an exemplary ultra-sound receiver coupled to the board or writing surface.

FIGS. 6B-6C provide side views of the ultra-sound receiver.

FIG. 6D provides a top view of the ultra-sound receiver.

FIG. 7A provides an exploded view of attaching the terminal of the piezzo film to the PCB.

FIG. 7B provides another perspective of the electrical contacts between the piezzo film and the PCB.

FIGS. 8A-8C provides different image of the piezzo film and portions thereof.

### DETAILED DESCRIPTION OF EMBODIMENTS

The present invention will now be described in terms of specific, example embodiments. It is to be understood that the invention is not limited to the example embodiments disclosed. It should also be understood that not every feature of the apparatus and methods for determining a location of a digital pen and/or sending ultrasound signals from a digital pen and/or detecting ultrasound signals that propagate (for example, horizontally) within a “writing surface” is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

### Exemplary System 5 for Determining the Location of the Stylus 100

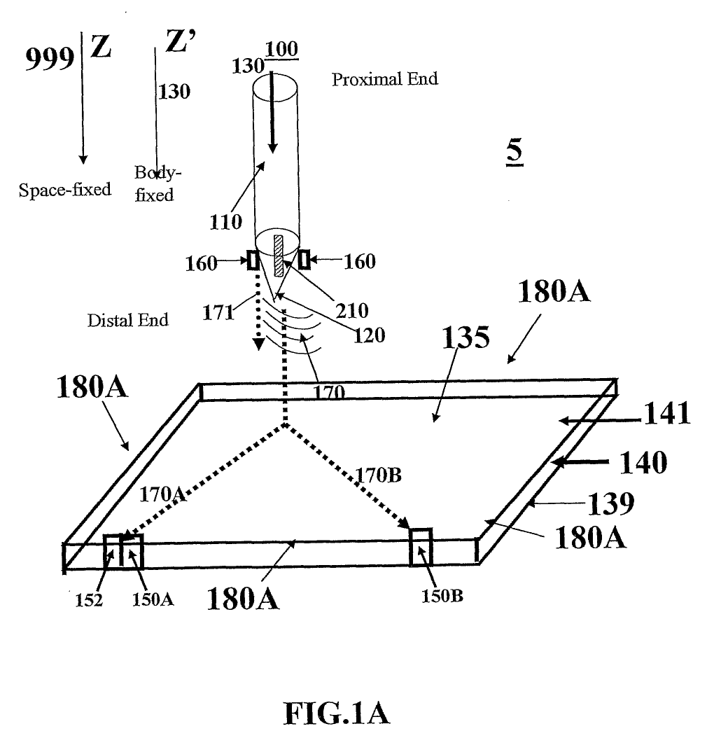

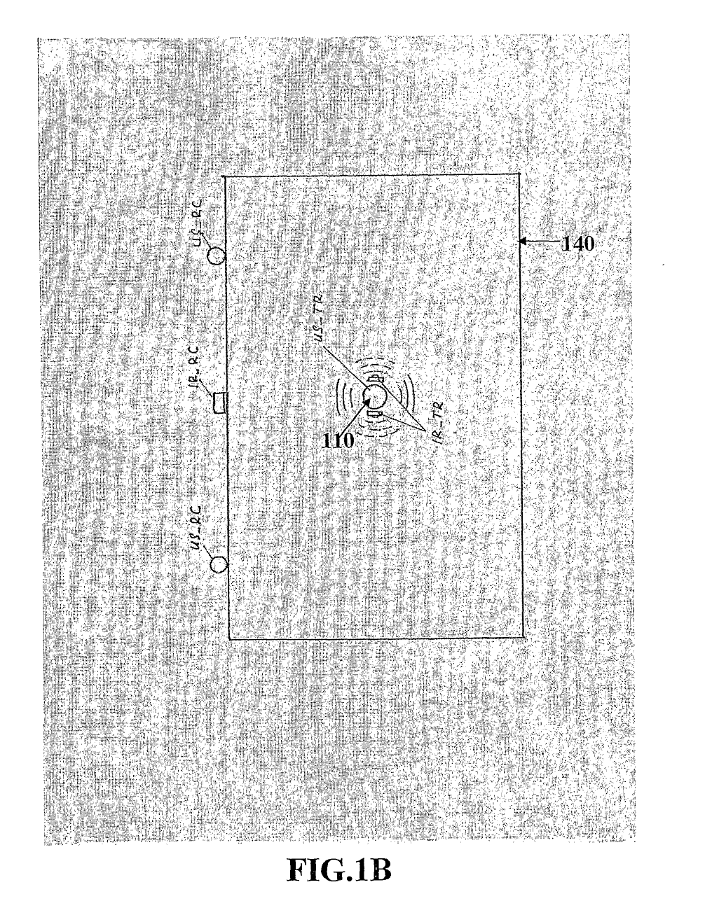

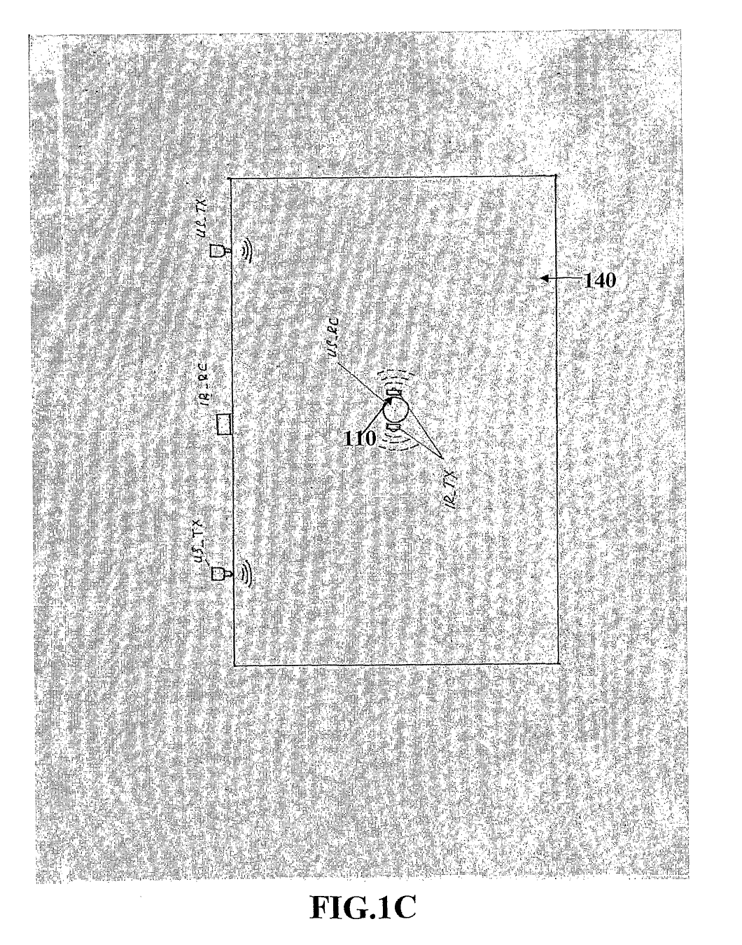

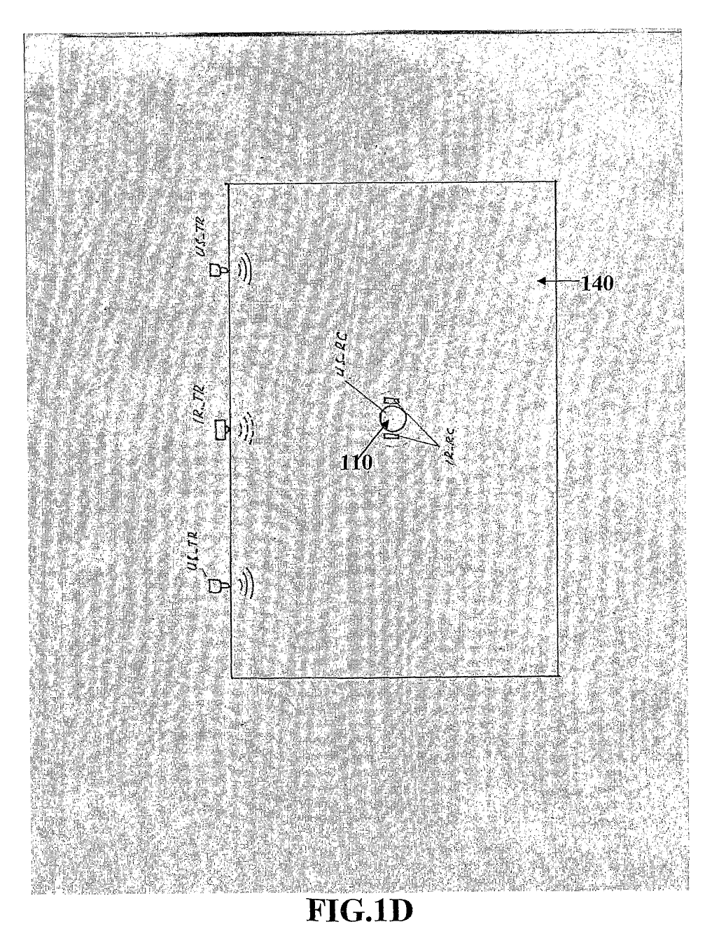

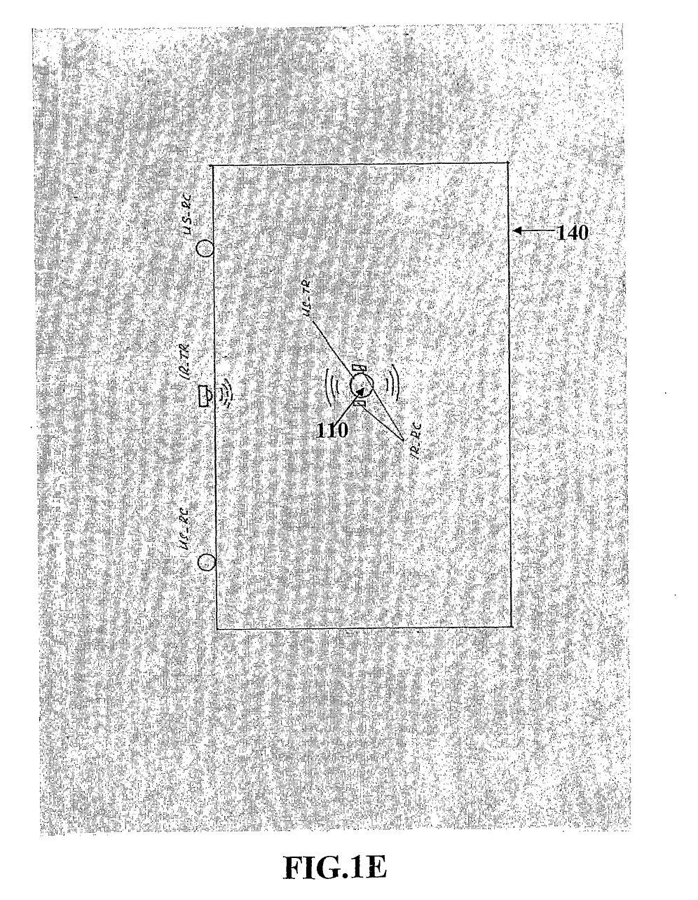

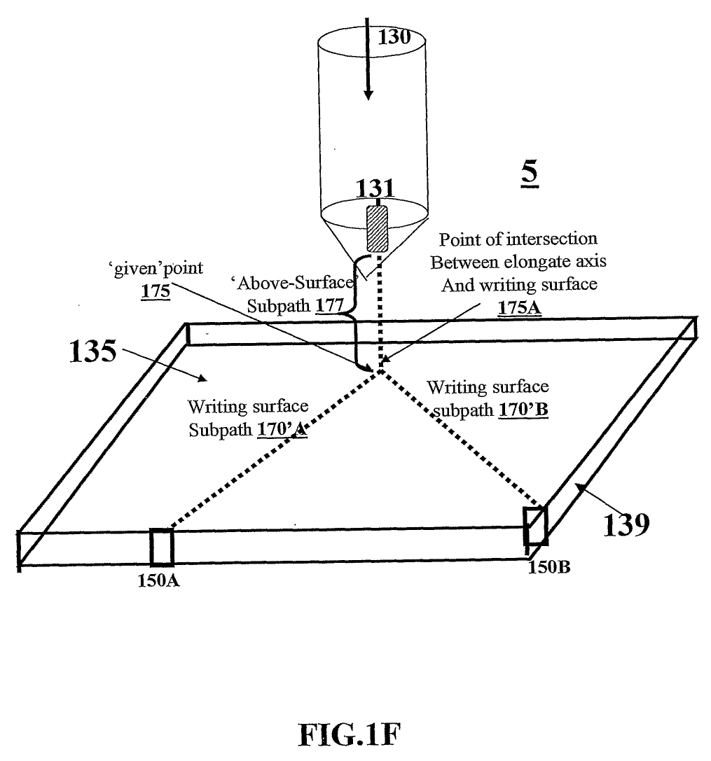

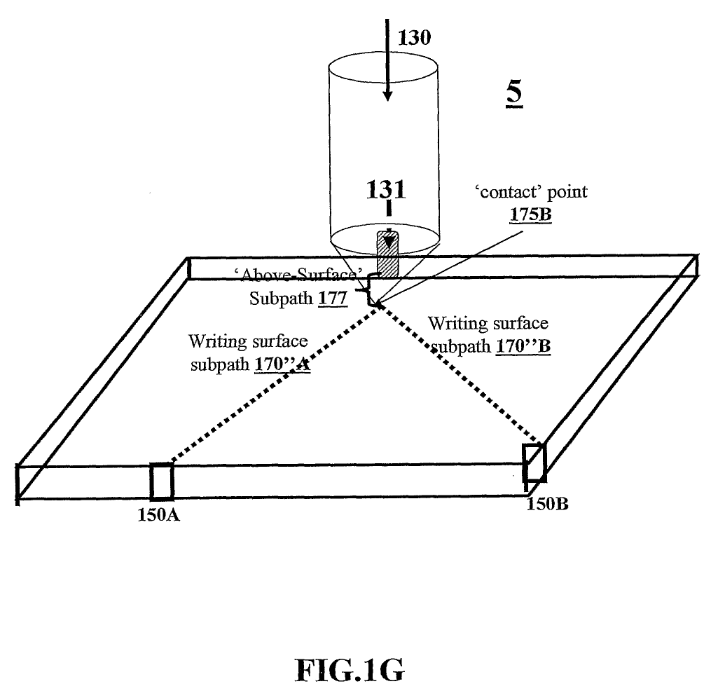

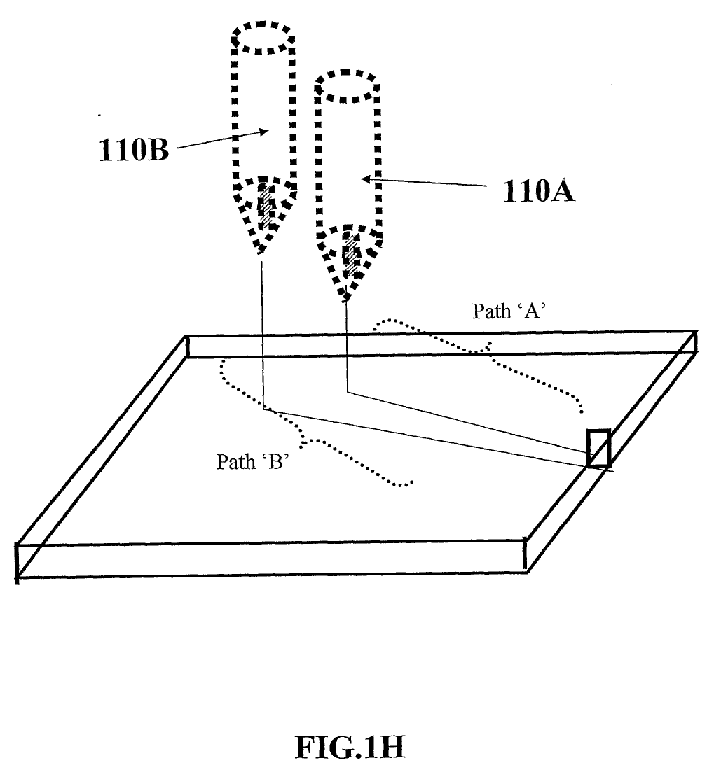

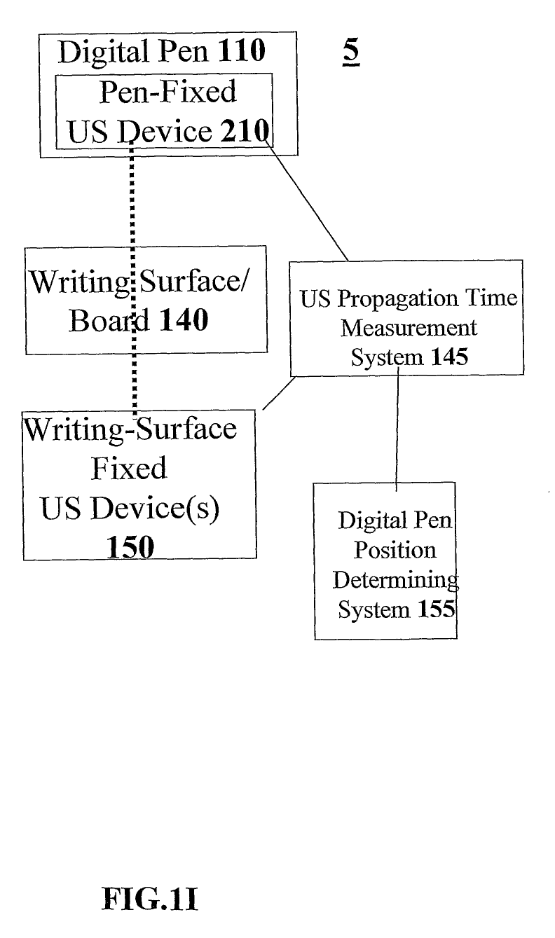

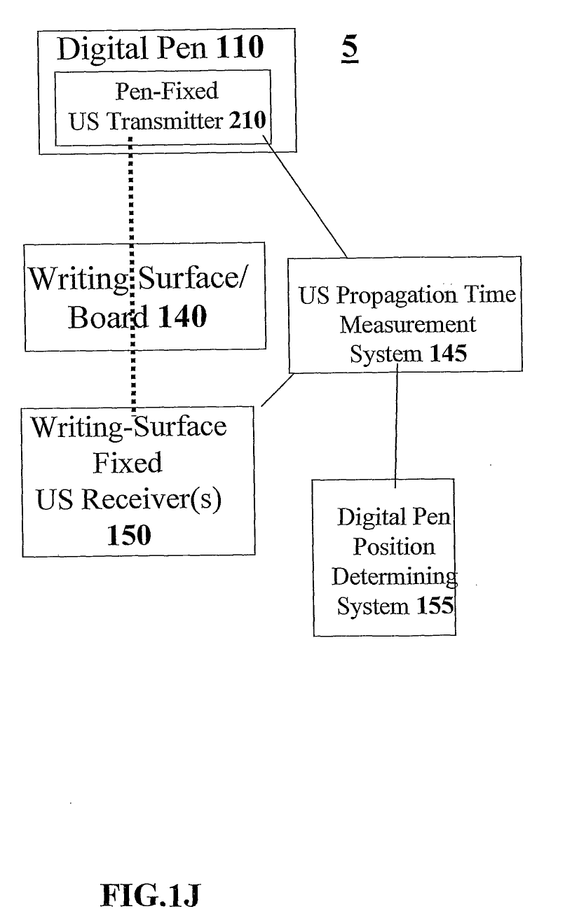

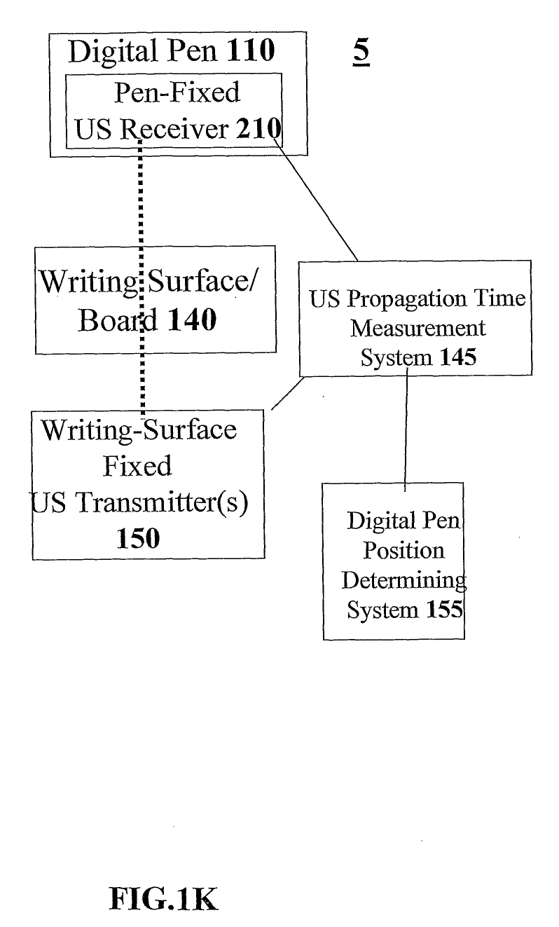

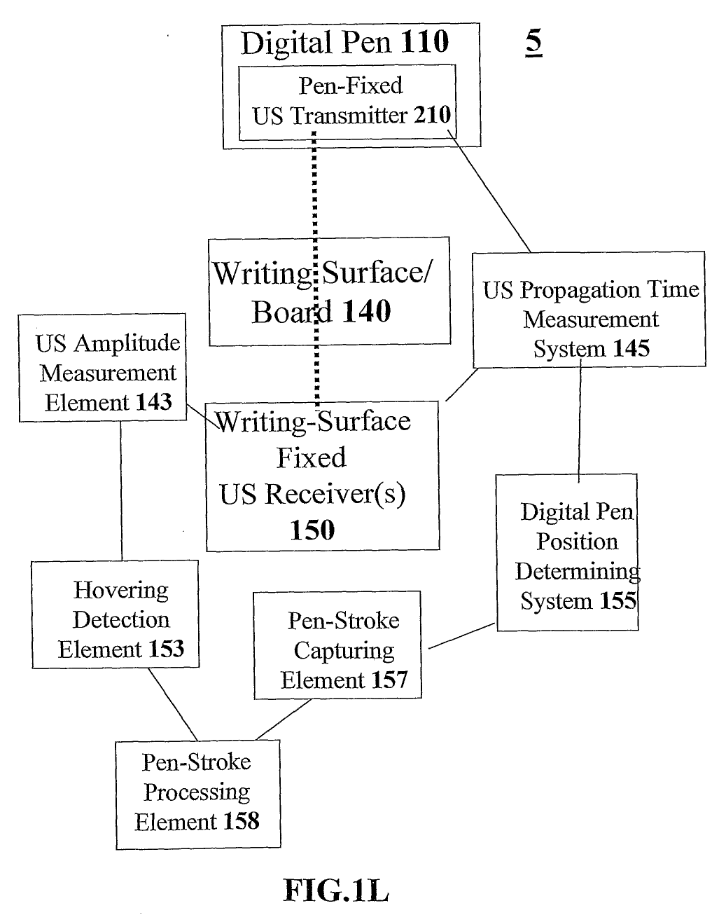

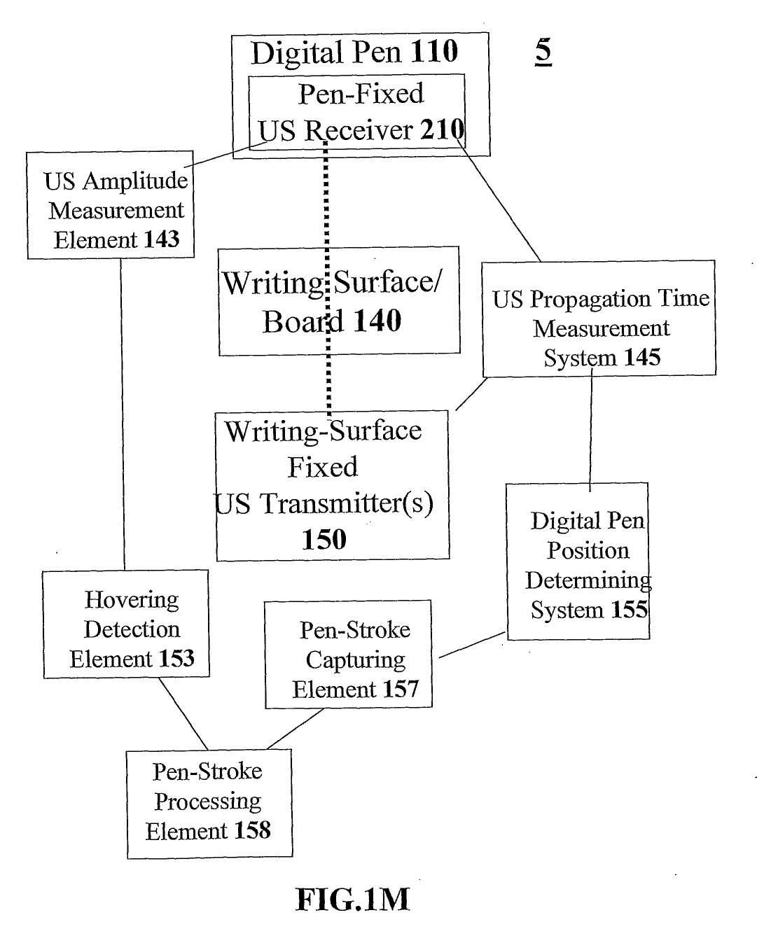

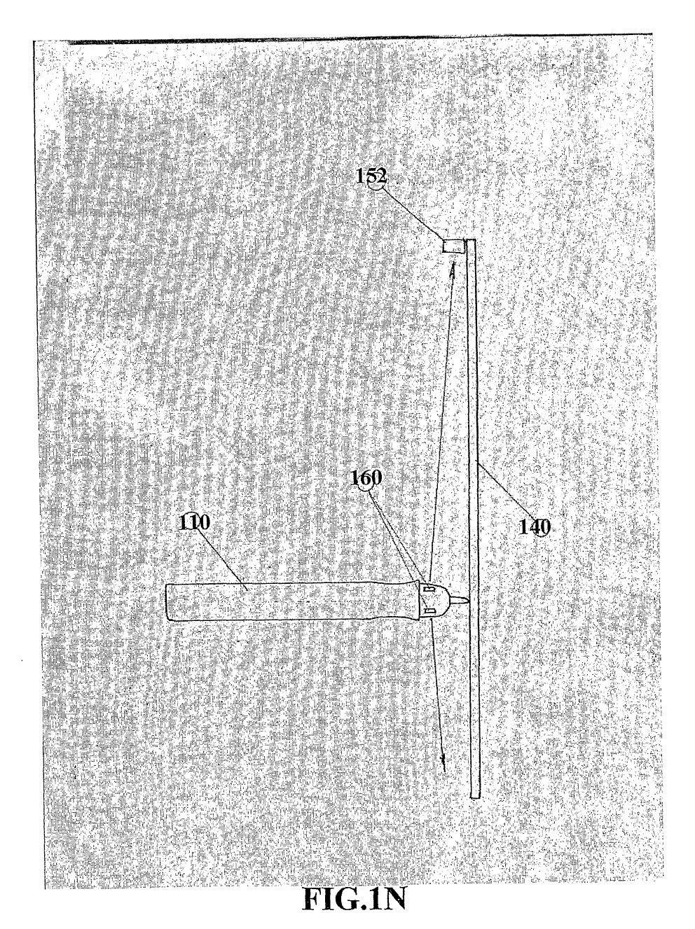

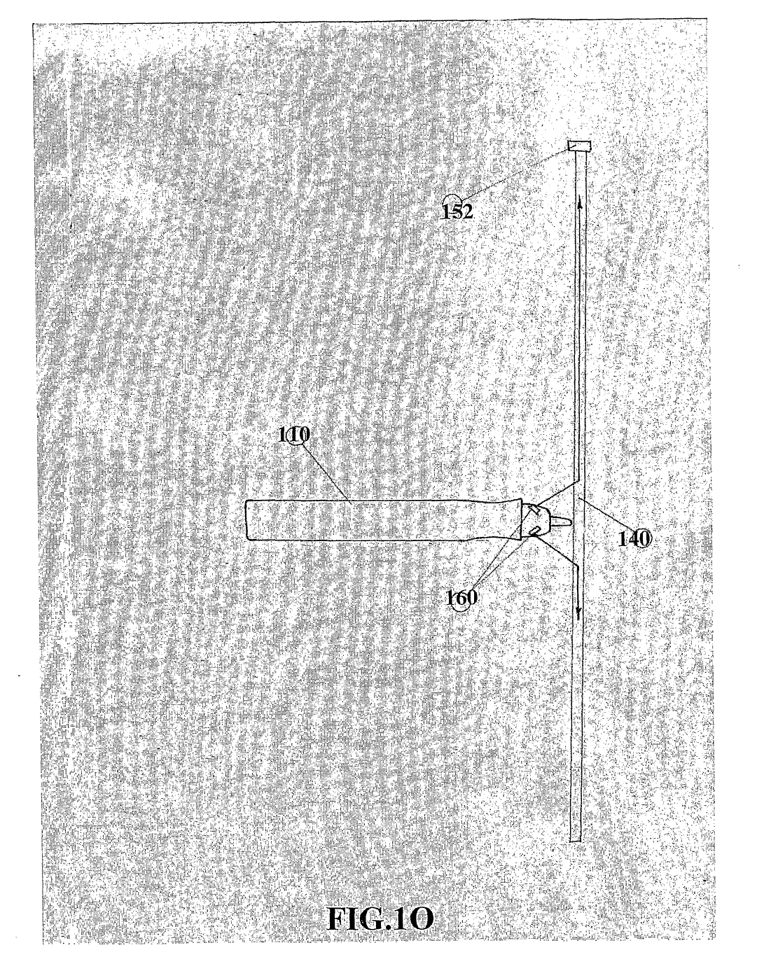

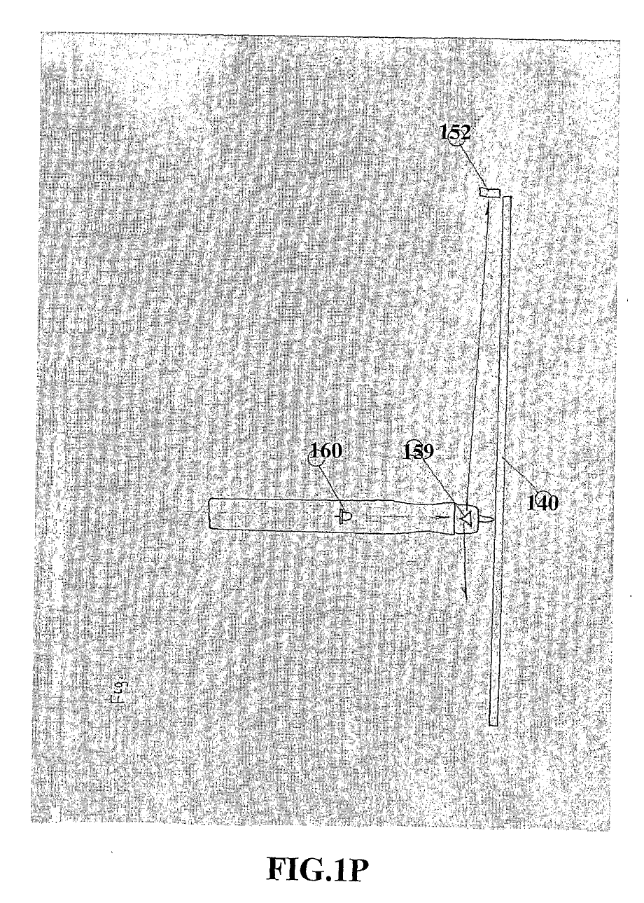

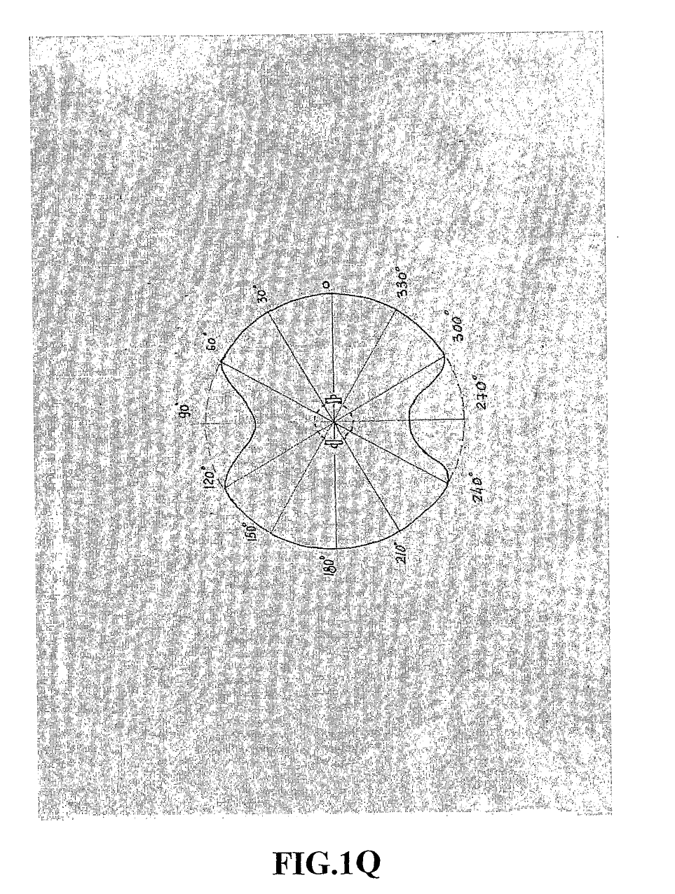

FIG. 1A provides an illustration of a system 5 in accordance with some embodiments of the present invention. As shown in FIG. 1A, a stylus or digital pen 100 (including but not limited to the stylus having an elongated body 110 as shown in FIG. 1) is used to ‘write’ (i.e. to mark a board or writing surface or alternatively without marking the board or writing surface—thus with ink or alternatively without ink) on and/or point to a ‘writing surface’ 140. In the example of the figures, ‘writing surface’ or board 140 is flat. It is appreciated that this surface may also serve other purposes. In some embodiments, it is extremely useful to point to or ‘write on’ (without ink) a computer screen, and thus, according to these embodiments, the computer screen serves as the ‘writing surface’.

The location of the stylus may be tracked when the stylus 100 contacts the writing surface 140 (i.e. pen down—see FIG. 1G) and/or when the stylus 100 ‘hovers’ (see FIG. 1F) over the writing surface 140. As will be discussed below, the tracking or determination of the location of stylus/digital pen 100 may be carried out to a given accuracy, which may, in some embodiments, dependent upon the height of digital pen/stylus 100 (or an element thereof) above writing surface 140.

The term writing surface 140 relates to an object on which the user writes (typically planar), and may have a “thickness” (for example, a “portable” writing surface such as paper) and may also be referred to herein as a board 140. In FIG. 1A, the “side surface” (i.e. showing the thickness) is numbered as 139, and the upper surface 135 of the board 140/writing surface 140 is numbered as 135.

In this application, the term board 140 and writing surface 140 are used interchangeably and may refer to a computer screen, a transparent overlay, a piece of paper, or any other object on which one may write or to which one may point. Thus, as shown in FIG. 1A, the upper surface of the writing surface 140 or board is labeled as 141. In some embodiments, the writing surface or board 140 is “thin”—having a thickness that is at most a certain percentage p (for example, at most 5%, or at most 2%, or at most 1%, or at most 0.5%, or at most 0.25%, or at most 1%) of the longest dimension of writing surface/board 140.

Although the stylus 100 in FIG. 1A has an elongated body 110 with a stylus tip 120 having a thickness that decreases along the elongate axis, this should not be construed as a limitation of the present invention.

There is no limitation on the size of the stylus. In exemplary embodiments, the length is between 8 and 12 cm, and the diameter is between 6 and 10 mm.

As depicted in FIG. 1A, the elongated stylus 100 may include a stylus or pen tip 120. A pen axis 130 of the elongated digital pen or stylus 100 which runs from the top of the stylus 100 to the stylus tip 120 is also depicted in FIG. 1A.

In order to track the location of the stylus 100, the stylus 100 includes at least one of an ultra-sound transmitter and/or receiver system and an optical (i.e. using light, for example, IR light) transmitter and/or receiver system. Determining the location of the stylus 100 at any given moment may be carried out, for example, by triangulation, for example, using electronic circuitry. As used herein, the ‘electronic circuitry’ refers to any combination of electronic hardware, software or firmware. Furthermore, some or all of the electronic circuitry may be located at any location within the presently disclosed system 5, including at the stylus, at a location associated with an ultrasound 150 or optical 152 receiver, in the host device 20, or any other location. As is known in the art, triangulation may be carried out by measuring the time of flight of the ultra-sound signal between the ultra-sound transmitter 210 (which produces ultra-sound waves) and each of the plurality of ultra-sound receivers 150, using the optical signal sent from the stylus 100 to the optical (i.e. IR) receivers 152 for signal synchronization.

It is noted that the optical transmitter 160 and receivers 152 are just one way (in this case, ‘wireless’) to provide ‘signal synchronization.’ Alternatively or additionally, signal synchronization may be provided in a ‘wired manner’ as is known in the art, using wires to ultrasound transmitter 210 and ultrasound receiver 150.

Although one of the ultrasound 150A and the optical 152 receivers are depicted in FIG. 1A as located in proximity of (and in contact with) the edge 180 of the board 140, this is not a requirement of the present invention.

Towards this end, in the example of the figures, the stylus 100 is also associated with a light or electromagnetic radiation transmitter 160 for producing light (i.e. 171), for example, IR light.

It is noted that although only two ultrasound 150 receivers and only one optical receiver 152 are depicted in FIG. 1A, this is not a limitation, and in exemplary embodiments additional receivers may be provided, for example, to provide a more accurate triangulation, or for any other reason.

Furthermore, it is noted that in FIG. 1A, a single transmitter (single ultrasound transmitter 210 and/or a single optical transmitter 160) in substantially a single location (i.e. a location associated with the stylus 100) is depicted, and receivers in a plurality of locations (for example, locations fixed relative to the board 140) are depicted. Alternatively or additionally, a plurality of ultra-sound and/or optical transmitters fixed relative to the board may be provided, and an ultra-sound receiver and/or optical receiver (for example, only a ultra-sound receiver and/or only a single optical receiver) may be associated (for example, connected to, for example, on the surface of, for example, embedded within) with the stylus 100.

Thus, the system provides at least one optical transmitter and at least one optical receiver. Furthermore, the system provides at least one of: A) at least one ultra-sound transmitter and at least two ultra-sound receivers and/or B) at least two ultra-sound transmitters and at least one ultra-sound receiver.

Various possible configurations are illustrated in FIGS. 1B-1E, where US_TR denotes ultra-sound transmitter; US_RC denotes ultra-sound receiver; IR_TR denotes infrared transmitter; and IR_RC denotes intra-red receiver.

Although the ultrasound transmitter 210 is depicted in FIG. 1A as embedded within the stylus 100, this is not a limitation of the present invention.

Although the optical transmitter 160 is depicted in FIG. 1A on the surface of housing of the stylus 100, this is not a limitation of the present invention.

Although in FIG. 1A, the ultrasound 150A and the optical 152A receiver are substantially in located together in one location, this is not a limitation of the present invention, and ultra-sound and infra-red receivers may be located in distinct locations.

A Comment about Space-Fixed Vertical Axis 999 and Body-Fixed Vertical Axis 130

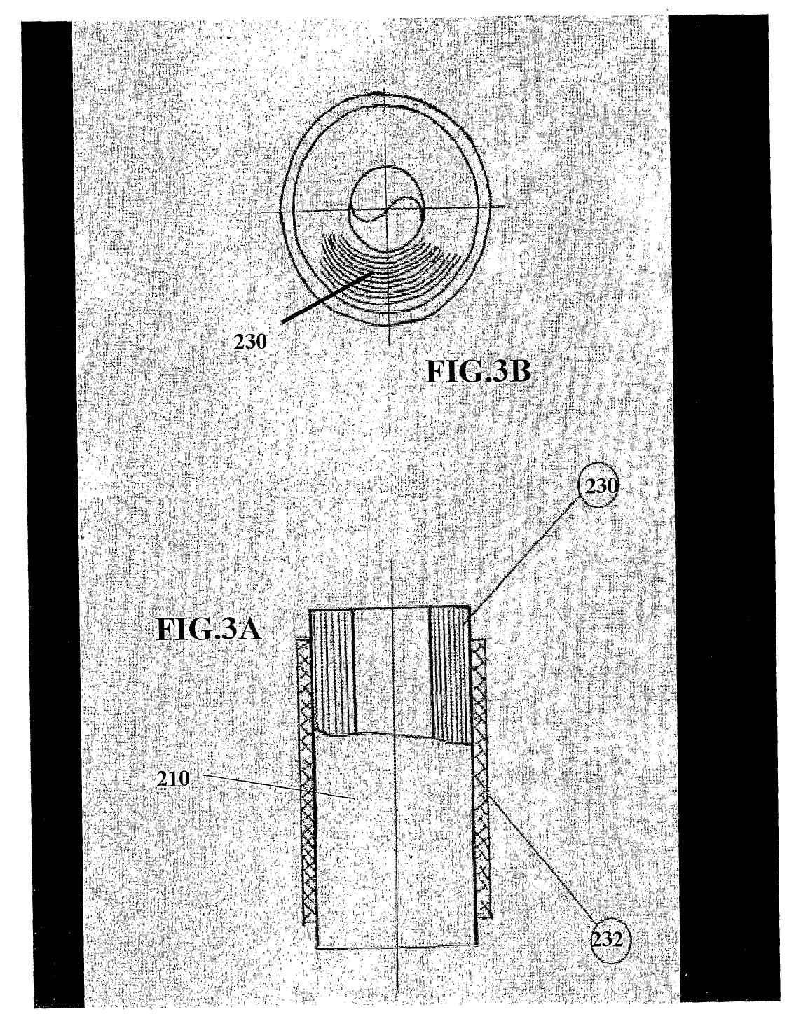

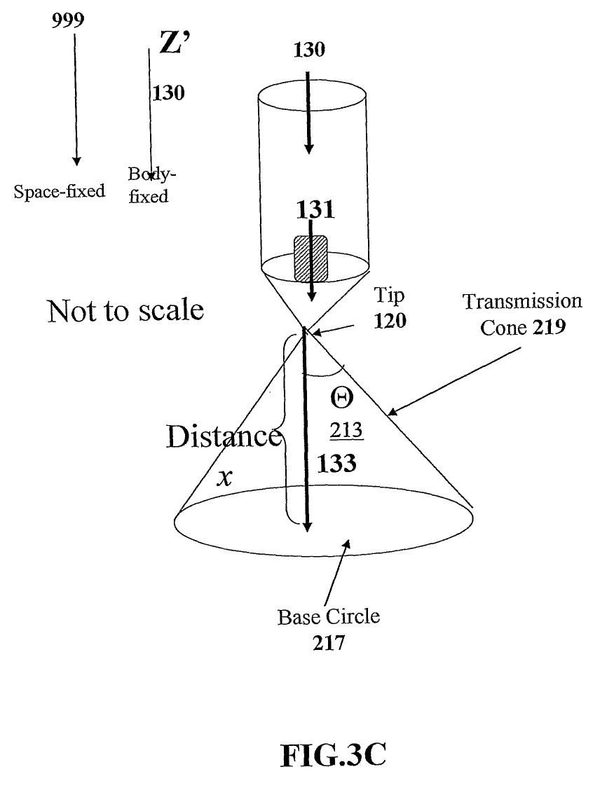

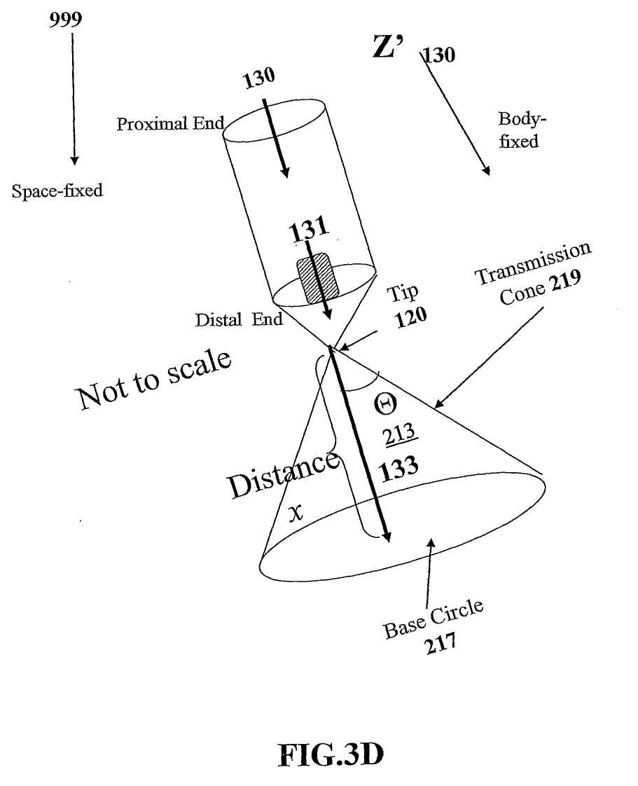

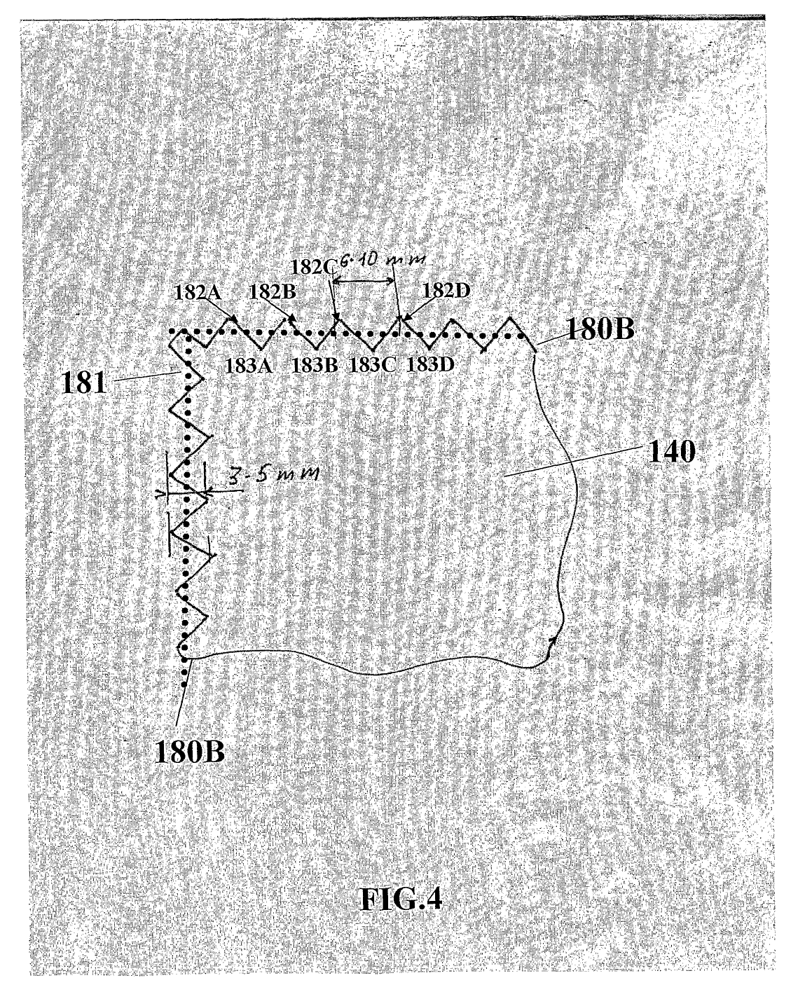

It is noted that in the example of FIG. 1, the pen is pointing “downwards”—i.e. body fixed elongate or vertical axis 130 is parallel to space-fixed vertical axis 999. Of course, if the user rotates the pen, this is not necessarily the case (see FIG. 3D).

In the present disclosure, “downward” and “upward” refer to relative to either (i) space-fixed vertical axis 999 or to (ii) body-fixed axis 130 (or another body-fixed axis that runs from the proximal end to the distal end, depending on the context as explained in the figures. This also refers to terms such as “up” and “down,” “upper” and “lower,” and the like.

### Transmission of One or Both of Ultra-Sound and Light Through the Board 140

It is noted that in exemplary embodiments, one or both of the ultra ultra-sound signal and the optical signal (i.e. IR) propagates through the board 140 when traveling from the stylus 100 (or a location associated with the stylus) to the ultra-sound 150 and/or optical 152 receiver. It is noted that FIG. 1A refers to “pen up” mode or hovering situation, and that when the pen contacts the writing surface 140 or board, it is note necessary for light and/or ultra-sound to traverse the air.

Not wishing to be bound by theory, it is noted that when the light and/or the ultra-sound travels from any point(s) associated with the stylus to the receiver(s) (i.e. 150 and/or 152) through the board 140 (as opposed to directly from the pen to the receiver) this may obviate the need to provide a “line of site” between the location(s) of transmission (i.e. the points transmitting at least one of ultra-sound and light) and the receivers.

Not wishing to be bound by theory, it is noted that transmission of the ultra-sound through the board 140 may allow the detection of pen up/pen down events, as explained below.

A Discussion of “Above-Surface” Propagation Subpath 177 and ‘Writing Surface Subpath 170” with Reference to FIGS. 1F-1G

As is illustrated in FIG. 1F, when the sound leaves ultrasound transmitter 210, the transmitted ultrasound sound reaches each particular ultrasound receiver 150 via a path that includes: (i) an ‘above-surface’ or ‘air’ subpath 177 between ultrasound transmitter 210 and a ‘given point’ 175 on the surface of board or writing surface 140; and (ii) a respective ‘writing surface subpath’ 170 (i.e. 170A or 170B in the figure) between the ‘given point’ 175 and the particular ultrasound receiver 150 (i.e. 150A or 150B in the figure).

In general, a “given point” 175 is any point on writing surface 140. In the example of FIG. 1F, the ‘given point’ 175A is defined by the point of intersection between: (i) an elongate axis of ultrasound transmitter 131; and (ii) writing surface 140.

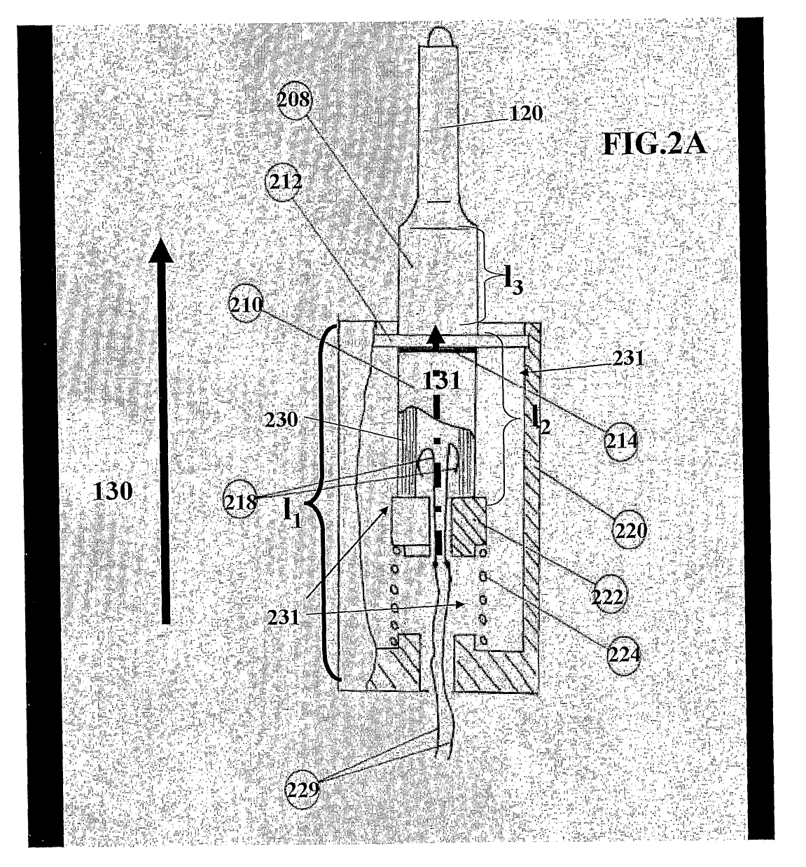

It is noted that in some embodiments, ultrasound transmitter 210 (or alternatively an ultrasound receiver) includes an elongate structure (for example, a piezzo film cylinder such as actuator 230 illustrated in FIG. 2), and sound generated by ultrasound transmitter 210 substantially propagates out of digital pen or stylus 100 via a line defined by the elongate axis 131 of the ultrasound transmitter 210. This generated sound thus reaches writing surface 140 “substantially” at the point defined by the intersection of elongate axis 131 and writing surface 140, or at nearby location within a given tolerance defining the term “substantially.” This tolerance may be, for example, equal to 30% (or 20% or 10% or 5%) a distance to a “closest” ultrasound receiver 150 to the contact point tip 120 of housing 110 of digital pen or stylus 100.

In the example of FIG. 1F, digital pen 110 is ‘above’ or “over” writing surface 140—i.e. not in contact with writing surface 140. In this example, the “writing surface sub-paths” are denoted with the “prime notation”—170A′, 170B′, etc.

In the example of FIG. 1G, digital pen 110 is ‘on’ writing surface 140. In the example of FIG. 1G, the ‘given’ point may be either (i) the contact point 175B between the tip 120 of digital pen 110, (ii) the intersection point as defined in FIG. 1B. This ‘given point’ may have “substantially” this location within a given tolerance. This tolerance may be, for example, equal to 30% (or 20% or 10% or 5%) a distance to a “closest” ultrasound receiver 150 to the contact point 175B

In the example of FIG. 1G, digital pen 110 is ‘on’ writing surface 140—i.e. in contact with writing surface 140. In this example, the “writing surface sub-paths” are denoted with the “double prime notation”—170A″, 170B″, etc.

Depending on where the pen 110 is located (i.e. how far the pen is above writing surface 140), in different embodiments, the ratio between the length of above-surface sub-path 177 and any given writing sub-path 170 may vary. In different example, this ratio may be less than 10, less than 5, or less than 1. In different embodiments, this ratio may be at least 0.5, at least 1, or at least 2.

In some preferred embodiments (i.e. where the ‘given point’ is any point on writing surface 140), a length ratio between the “above-surface” sub-path 177 and the writing surface sub-path 170 is at least 0.1 and at most 10.

In some embodiments in accordance with the example of FIG. 1G, ultrasound transmitter 210 causes sound vibrations of tip 120. Tip 120 is in contact with writing surface 140, and thus sound vibrations of tip 120 cause sound vibrations to propagate (for example, horizontally) within writing surface 140.

The Board 140

Propagation of Light Parallel to the Surface of the Board

There is no limitation of the material from which the board or writing surface 140 may be fashioned. Exemplary materials include but are not limited to glass, plastic, wood and metal. In exemplary embodiments, for example, where the board 140 is used as a transparent overlay for a computer screen, the board may be transparent.

In some embodiments, the board 140 may be laminated, for example, with a layer of anti-scratch protective material and/or a layer of glass. For example, for embodiments where light waves (e.g. IR) are propagated through the board 140 or a layer of the board 140 or on a surface 141 of the board 140, the board includes (for example, the upper surface 141) a material operative to propagate light such as glass or a transparent or semi-transparent plastic. In some particular embodiments, the surface of the board 140 may be rough or not smooth (for example, including micro-scratches) to facilitate the penetration of light into the board 140 (i.e. to avoid reflection) and/or to facilitate the propagation of light (e.g. IR) along the surface of the board 140 (i.e. to function as a ‘wave guide’) and/or in a direction that is substantially parallel to the local surface of the board 140.

As used herein, a “waveguide” is a device that substantially controls the propagation of an electromagnetic wave so that the wave is forced to substantially follow a path defined by the physical structure of the guide. In the present example, board or writing surface 140 may be configured to force light to follow a path that is substantially (i.e. within a tolerance of at most 10 degrees, or at most 5 degrees, or at most 1 degree) parallel to a plane defined by an upper surface of writing surface 140 or board for a distance that is at least 20% (or at least 50% or at least 75%) a distance between optical transmitter 160 and optical receiver 152.

Thus, in exemplary embodiments, the light may penetrate into the material of the board 140 (for example, through the not-smooth surface) and then propagate within this material of the board.

There are no limitations on the dimension of the board. Typically, the dimensions of the board are on the same order of magnitude as a typical piece of paper (i.e. A4 or 8½ by 11), though this is not a limitation. In exemplary embodiments, the length and/or width of board is between 15 cm and 60 cm.

### Propagation of Ultra-Sound Parallel to the Surface of the Board

It is noted that in FIG. 1A the edges 180 of the board 140 are drawn as substantially straight. Nevertheless, this is not a requirement of the present invention, and in some embodiments, for example, embodiments where the ultra-sound propagates through the board 140, it may be preferred to provide an echo reducing mechanism. One potential problem is that reflected ultra-sound waves (that ‘echo’ from the edge of the board) may interfere with the ultra-sound wave traveling from the transmitter 210- to the receiver, and thus, the edge 180 of the board is configured to reduce (i.e. by reducing the magnitude of reflected ultra-sound waves and/or by shaping the edge of the board such that reflected ultra-sound waves interfere with each other to, at least in part, cancel each other out) this unwanted phenomenon.

For example, one or more edges 180 of the board 140 may not be a “straight edge” (not a straight line) as shown in FIG. 1A. According to the embodiment depicted in FIG. 4, the board has a “jagged edge” 180B deviations from the ‘average’ line 181 (shown as a dotted line) characterizing the edge. This jagged edge includes a plurality of ‘peaks’ 182 and ‘troughs’ 183. In exemplary non-limiting embodiments, the amplitude of these deviations is between 3 and 5 mm—thus, in exemplary embodiments, the ratio between the amplitude of these deviations and the longest dimension of the board is between 0.006 and 0.03. Typically, the amplitude of the deviation varies over a distance of between 6 to 10 mm (a distance that is between 0.012 and 0.06 the longest distance of the board).

In some embodiments, the exact curvature may be selected in accordance with the wavelength of the ultra-sound used in the system.

Alternatively or additionally, the edge of the board includes a material (for example, a coating) operative to damp the amplitude of reflected ultra-sound waves. In some specific non-limiting examples, this ultra-sound damping material may include one or more of an adhesive material (for example, a material that adheres to glass), a resin material (including but not limited to synthetic resin and turpentine resin), any amorphous and/or soft material (for example, wax), a material that is poorly soluble or insoluble in water but soluble in nonpolar organic solvents (for example, wax), and polyamide EVA, ethylene, a copolymer such as vinyl acetate copolymer, wax. The exact amounts of materials provided, types of materials provided, and ratio of components of materials provided may vary in accordance with the structure of the board 140, and the skilled artisan will be able to select appropriate materials for given boards 140.

In one particular example, the ultra-sound damping material includes one or more of (or all of) polyamide EVA, synthetic resin (for example, 5% synthetic resin), ethylene, vinyl acetate resin copolymer, turpentine resin (for example, 40% turpentine resin), and wax (for example, 5%).

Although the board 140 in FIG. 1A is depicted as planar (or substantially planar), this should not be construed as a limitation of the present invention.

### The Board 140 as a Transparent Overlay

Although the writing surface 140 is referred to as a board 140, this does not imply that the writing surface 140 (board) is rigid. In some embodiments, the board 140 is transparent, and/or flexible or semi-flexible. In one exemplary application, the board 140 may be provided as a transparent screen overlay, to be layered over the display 30 screen (including but not limited to CRT screen or an LCD screen). This may allow a user to “write on the screen” and to record pen strokes.

### Ultrasound Transmitter 210

As shown in FIG. 1A, there is an ultra-sound transmitter 210 associated with the stylus 100 ultra-sound waves from the ultra-sound transmitter 210 propagate though the writing surface 140 (in some embodiments a ‘board’, in some embodiments a transparent writing surface, for example, of plastic or glass) to at least two ultrasound receivers 150 at fixed locations relative to the writing surface 140. In some embodiments, and as shown in FIG. 1F, when the pen is ‘up’ ultra-sound waves produced by the ultra-sound transmitter 210 may first propagate through the air via “above-surface subpath” 177 (i.e. ultra-sound waves) before reaching the board, when the pen is not contacting the surface (i.e. ‘pen up’ mode). Upon reaching the writing surface 140 or board, the ultra-sound waves then propagate through the writing surface 140 or board to reach the plurality (i.e. at least two) of ultra-sound receivers.

Furthermore, it is noted that in some embodiments, the ultra-sound waves propagate through at a portion of the stylus towards the board or writing surface 140, before subsequently propagating through the board or writing surface 140.

### Ultrasound Propagation Time Measurement System 145 and Digital Pen Position Determining System 155

A Discussion of Accuracies of Determining Pen Locations with Reference to FIG. 1H

In some embodiments, the time of flight between the ultra-sound transmitter 210 and each ultra-sound receiver 150 may be determined. Time of flight data may be useful, for example, for determining the location of the stylus by triangulation.

Thus, it is noted that it is possible to determine (to a certain degree of accuracy) the location of digital pen 110 by measuring respective ultrasound travel times between ultrasound device 210 (i.e. a pen-fixed transmitter or receiver) and each particular writing-surface 140-fixed (or board 140-fixed) ultrasound receiver The principle of “triangulation” of digital pens is based on determining multiple times of flight (at least, possible more) of ultrasound traveling between: (i) a pen-fixed ultrasound device (i.e. transmitter or receiver); (ii) each of a plurality of writing board fixed ultrasound devices (i.e. transmitter or receiver). In the event that the ultrasound travels along a straight line between the pen-fixed ultrasound device and the writing-surface fixed ultrasound devices, then the location determined is a “unique location.” In certain embodiments of the present invention, however, the measured ultrasound does not travel on a “straight line” between the pen-fixed ultrasound device and the writing-surface fixed ultrasound devices. Rather, the ultrasound travels (either from the pen-fixed ultrasound devices to the writing-surface fixed ultrasound devices or vice versa) along a path that includes (i) an ‘above-surface’ or air sub-path 177 (ii) a writing surface subpath 170. Thus, in some embodiments, the determined location may not be unique, but rather there may be multiple locations associated with a given set of ultra-sound propagation time measurements.

This is illustrated in FIG. 1H, where for two different pen locations 110A and 110B, the ultra-sound propagation time associated with a given writing-surface fixed ultrasound device 110 is equal. Thus, when trying to determine the location of the pen or the pen-fixed ultrasound device form the ultra-sound propagation times, more than one location may be possible—i.e. the “answer” may not be unique as shown in FIG. 1H.

Nevertheless, all locations that provide the given measured ultra-sound propagation times are typically “close” to each other. Thus, when the “location of the digital pen” (i.e. either the digital pen or a component thereof—for example, the pen-fixed ultrasound transmitter or receiver) is determined, there may be certain degree of “inaccuracies” in this determination. The present inventors are disclosing that this is acceptable to certain applications—for example, systems for recording pen strokes.

Also, it is noted that “determining the location” of the pen does not require determining the location in three dimensions. For example, it may be difficult to determine the “height” of the digital pen in this manner, and when “determining the location” it may be sufficient to determine the location in two dimensions—for example, ‘horizontal dimensions” defined according to writing surface 140.

Thus, in some embodiments, the location of the stylus 100 is determined (for example, using triangulation based on time of flight to the receivers) not exactly, but approximately, within a given tolerance. Not wishing to be bound by theory, it is noted that in some embodiments, the margin of error associated with a determined location (i.e. along the x-y plane defined by the writing surface 140) may be greater when the pen is not contacting the writing surface 140 and ultra-sound waver propagate through the air before reaching the board or writing surface 140 (i.e. greater than the margin of error with a determined location when the pen or stylus 100 contacts the writing surface 140, i.e. in ‘pen down’ mode).

Nevertheless, there are certain applications where it is nevertheless useful to compute the location of the pen or stylus 100 during ‘hovering,’ even though the computed x-y location may only be approximate, and may not be completely accurate. For example, when the ‘hovering pen’ is being operated with the host device 10 in ‘mouse mode,’ the user typically may views the screen, and move the pen in order to solicit a motion of the ‘mouse pointer’ displayed on the display 20 screen, and typically, there may not be a need for capturing pen strokes in ‘hovering mode’. Thus, according to these examples (i.e. associated with using a hovering pen in mouse mode) if the tracked location of the pen has a certain degree of error, it is assumed in many applications, that the user will adjust the position of the pen accordingly (user hand-eye feedback).

### A Discussion of FIGS. 1I-1K

FIG. 1I provides a block diagram of an exemplary system for determining the location of a digital pen. According to the example of FIG. 1I, a pen-fixed ultrasound device 210 transmitted sound, via writing surface/board 140, to a plurality of writing surface ultrasound receivers 150. An ultrasound propagation time measurement system 145 determines respective ultrasound propagation times via the writing surface/board 140. Ultrasound propagation time measurement system 145 may be implemented in any combination of hardware or software, and may be deployed in part or in whole at any location(s).

In accordance with the determine propagation times, digital pen position determining system 155 determines the position of digital pen 110. Digital pen position determining system 155 may be implemented in any combination of hardware or software, and may be deployed in part or in whole at any location(s).

In the example of FIG. 1J, the pen-fixed ultrasound device 210 is a transmitter (similar to the example of FIGS. 1A, 1F-1G) and the writing-board fixed ultrasound devices 150 are receivers. In the example of FIG. 1J, the pen-fixed ultrasound device is an ultrasound receiver and the writing-board fixed ultrasound devices are receivers.

In the example of FIG. 1K, the pen-fixed ultrasound device 210 is a receiver and the writing-board fixed ultrasound devices 150 are transmitters. In the example of FIG. 1J, the pen-fixed ultrasound device is an ultrasound receiver and the writing-board fixed ultrasound devices are receivers.

### Ultra-Sound And Hovering Mode: A Discussion of FIGS. 1L-1M

As illustrated in FIG. 1A, the ultra-sound transmitter 210 may be a uni-directional ultra-sound transmitter 210 operative to transmit a majority of, or substantially all ultra-sound energy in a biased in a given direction (in this case, along the pen axis 130 which runs from the top of the stylus 100 to the stylus tip 120) rather than isotropically. Not wishing to be bound by theory, this may be useful for providing a strong enough signal to the receivers 150. Furthermore, not wishing to be bound by theory, this may also be useful for providing a transmitter operative to use shorter pulses, which can improve the bandwidth of the ultra-sound communications channel.

As mentioned above, when the pen ‘hovers’ above the writing surface 140 or board, the ultra-sound waves may first prorogate through the air before propagating through the writing surface 140 or board. In some embodiments, the amplitude of the ultra-sound waves received at the receivers is determined, and it may be determined whether or not the pen or stylus is hovering or contacting the writing surface 140 or board (or alternatively, a distance between a fixed point on the stylus 100 and the writing surface 140) in accordance with a determined amplitude of the received ultra-sound wavers (i.e. received at the receiver 150).

More specifically, the amplitude of ultra-sound signals (i.e. transmitted by the stylus and/or pen and received by ultra-sound receivers 150 at the board, or transmitted at the board and received by an ultra-sound receiver in the stylus and/or pen) may increase by an order of magnitude (i.e. at least a factor of 3, or at least a factor of 7) when the stylus, previously hovering, is broad into contact with the writing surface of board 140. Similarly, the amplitude of ultra-sound signals decrease by an order of magnitude (i.e. at least a factor of 3, or at least a factor of 7) when the stylus, previously in contact with the writing surface of board 140, is made to ‘hover’ over the surface of the writing board 140.

Thus, FIG. 1L, illustrates a system where the system includes: (i) an ultrasound amplitude measurement element 143 (i.e. operative to work in coloration with an ultrasound receiver—for example, to determine sound amplitudes from amplitudes of piezo film vibrations). Based upon this, it is possible to determine if there is “hovering” or not using a hovering detection element 153 (i.e. implemented in any combination of hardware and/or software).

In the event that the pen is “above” writing surface 140 and is “hovering,” pen strokes may be handled differently from the case where the pen 100 is in contact with writing surface 140. In one non-limiting case, when the pen is in contact or “down” pen strokes are handled as “writing” and recorded as such. When the pen is “up” or “hovering,” pen strokes are operative to “move the cursor” of digital pen 100 without recording digital writing.

This is shown in FIG. 1L where the3 system includes a pen-stroke capturing element 157 (i.e. for determining changes in the pen location), and a pen stroke processing element 158—for handling pen strokes in a manner that is contingent on whether or not the pen is “hovering” or in “pen-down” mode. Each of pen-stroke capturing element 157 and pen-stroke processing element 158 may be implemented in any combination of software and/or hardware.

FIG. 1M is provided in accordance with the example of FIG. 1K. In this case, the amplitude of ultrasound vibrations detected by the pen-fixed ultrasound receiver is measured.

### Optical Transmitter 160

For the purposes of “synchronization” of ultrasound signals, in the specific example of FIG. 1A, there is an optical transmitter 160 (for example, IR) associated with the stylus 100. Light (for example, 171) emitted from the optical transmitter propagates through the board to the optical receiver 152. There is no limitation on the structure of the optical transmitter. In exemplary embodiments, the optical transmitter is an “omni-directional” optical (i.e. IR) transmitter.

FIGS. 1N-1Q illustrate side views of configurations of the optical transmitter 160 and the optical receiver. As illustrated in FIG. 1N, the IR may follow a “line of site path” from the transmitter 160 to the receiver 152. In the embodiment illustrated in FIG. 1O, the IR radiation is transmitted first from the optical transmitter 160 to the board, and then through the board 140 to the optical receiver 152. In the embodiment illustrated in FIGS. 1P, 1R is transmitted along the pen axis 130 from a transmitter to a beam splitter 159 and is transmitted in different directions.

As illustrated in FIG. 1Q, it is noted that typically, IR is not transmitted in a single direction, but may be transmitted in different directions so that for different given pen orientations (i.e. because the user may re-orient the pen during use), the transmitted IR can still reach that optical receiver 152. FIG. 1Q illustrates a typical profile of intensity of transmitted IR as a function of direction.

### Structure of the Ultrasound Transmitter or Actuator 210

An exemplary ultra-sound transmitter 210 that is embedded within an external housing 220 of the stylus 100 is illustrated in FIG. 2, though other particular structures and implementations are contemplated by the present inventors. It is understood that although an “embedded ultra-sound transmitter 210” is illustrated (i.e. embedded within an elongate cavity 231 of elongate housing 220 the stylus 100), that this is not a limitation of the present invention.

Furthermore, although the present inventors are disclosing the ultrasound transmitter 210 in the context of the system of FIGS. 1A-1I (i.e. the presently disclosed system 5), that the presently disclosed uni-directional transmitter 210 as well as the system comprising the uni-directional transmitter 210 and the stylus 100 is useful in a variety of contexts, and not only in the presently disclosed system 5.

In the example of FIG. 2, the ultra-sound transmitter does not transmit ultra-sound isotropically (i.e. in all directions), but rather, ultra-sound wavers biased in a particular direction (i.e. along pen axis 130) are provided. This may be referred to as a substantially “uni-directional” ultra-sound transmitter (i.e. ultra-sound), though it is appreciated that all ultra-sound waves typically do not propagate in exactly a single direction.

Thus, in exemplary embodiments, a majority of power associated with the ultra-sound waves that leave the uni-directional ultra-sound transmitter/transmitter/actuator 210 and/or the pen tip 120 is substantially in the direction (i.e. within 10 degrees of a given vector (the vector of transmission), for example, the vector defined by pen axis 130, and/or within 25 degrees of this transmission vector, and/or within 45 degrees of this transmission vector, and/or within 70 degrees of this transmission vector, and/or within 90 degrees of this transmission vector. Related examples of the ‘substantially uni-directional transmission feature” are discussed below with reference to FIGS. 3C-3D.

This anisotropic ultra-sound transmission profile may (i.e. ultra-sound broadcast or transmission in a substantially un-directional manner) may be provided in a number of ways. According to the example of FIG. 2, the transmitter includes a ultra-sound transducer (i.e. ultra-sound generated by a vibrating object (for example, a vibrating membrane or a film) in accordance with a provided electrical signal). Thus, the actuator 230, in some embodiments, includes a vibrating object which converts electrical signals to mechanical movements in order to create pressure waves (i.e. ultrasound waves)

One example of such a “vibrating object” is piezzo film 230 such as coiled piezzo film—in this case, rolled to have a ‘cylindrical’ shape. As shown in FIG. 2, the piezo film 230 receives an electrical signal from electrical leads 229 such as by a pair of wires or any other electrically conductive object which is electrically coupled (for example, by electrical contacts 218) with the piezzo film 230. This electrical signal (i.e. one or more excitation pulses) may be provided by electronic circuitry (not shown), for example associated with, attached to or embedded in the stylus, powered with an electrical power source (not shown).

In FIG. 2, the ‘elongate axis’ 131 of ultrasound transmitter 210—in this case, the axis of the cylinder of piezzo film 230, is parallel to the elongate axis 130 of digital pen/stylus 110. Nevertheless, it is appreciated that this is not a limitation. In some embodiments, the ‘elongate axis’ 131 of transmitter 210 is ‘substantially parallel to the elongate axis 130 of pen 110—i.e. parallel within a tolerance of, for example, 45 degrees, or 20 degrees, or 10 degrees.

There is no limitation on this electrical power source (not shown). It may include a battery (such as a rechargeable battery) or may include a rechargeable “capacitor.” It is recognized that the latter may be rechargeable over a shorter time scale, and thus, in some embodiments, an electronic “ink well” is provided, which a user may engage to recharge the capacitor.

Although certainly not a limitation of the present invention, in exemplary non-limiting embodiments between about 10 to 20 turns of piezzo film 230 are provided. In exemplary non-limiting embodiments, the radius of the piezzo film is about 2-3 mm and the length of the piezzo film is between 2 and 5 mm.

As mentioned earlier, the ultra-sound transmitter or transducer 210 may be operative to provide ultra-sound with an anisotropic ultra-sound transmission profile (for example, a substantially ‘uni-directionally’ transmitted ultra-sound). This may be provided in a number of ways. According to the exemplary embodiment of FIG. 2, a ultra-sound reflector 222 (for example, constructed of plastic or any other appropriate material) is provided, for reflecting ultra-sound waves generated by the vibrating piezzo film 230 in the direction of vector 130.

This ultra-sound reflector 222 may be held in place, for example, with a compressible object such as a spring 224 (a ‘centering’ spring).

Thus, the piezzo film-reflector assembly may be held in place (i.e. relative to the proximal end of the stylus 100) with the compressible object. Furthermore, on the distal end of the style (i.e. toward the tip 120) the piezzo film may be attached to a support element between the ultrasound transmitter 210 or actuator (i.e. including piezzo film 230) bearing flange 212 using an adhesive, such as a double-sided adhesive film 214.

In some embodiments, the generated pressure wave of the ultra-sound is transmitted through the bearing flange 212 (for example, having a thickness of about 0.6 mm, for example, made of plastic) into a resonator 208. This resonator (and in particular, the length of the resonator) may be dimensioned in accordance with the resonant frequency for a wavelength of ultra-sound being used to allow for transfer of a maximum (or near-maximum) energy from the actuator to the tip of the stylus or pen (and no to the ultrasound receiver 250). This may be useful for transmitting a narrow band of ultra-sound. According to one non-limiting example, a value of l3 is between 3 and 4 mm.

Another view of the actuator or ultra-sound transmitter 210 is provided in FIGS. 3A-3B. According to the example of FIG. 3A, the piezzo film is provided within a protective pipe 232 which is located within the external stylus 100 housing 220.

### A Discussion of FIGS. 3C-3D and Body-Fixed Cone 219

FIGS. 3C and 3D provide illustrations of body-fixed geometric constructs (i.e. transmission vector 133, theta angle 213, base circle 217, and transmission cone 219 that are useful for explaining the “substantially uni-directional transmission feature.”

### Receivers

### Optical Receivers

In some embodiments one or more optical receivers are provided, for example, the optical receiver is located at or near the edge 180 (this may be easier to use or manufacture, especially for the case of a computer screen overlay where an optical receiver in the middle may obstruct the user's view of the computer screen) of the board 140, though this is not a requirement of the present invention

### Ultra-Sound Receivers

### Location

In some embodiments, an ultra-sound receiver 150 is provided, for example, fastened or attached to the writing board 140.

There is no limitation on where the ultra-sound receivers may be located relative to the writing board 140-the receivers 150 may, for example, be located near or at an edge 180 of the board 140, at or near the center of the board 140, or anywhere in between.

In exemplary embodiments, one or more ultra-sound receivers 150 may be located at or near an edge 180 of the board 140.

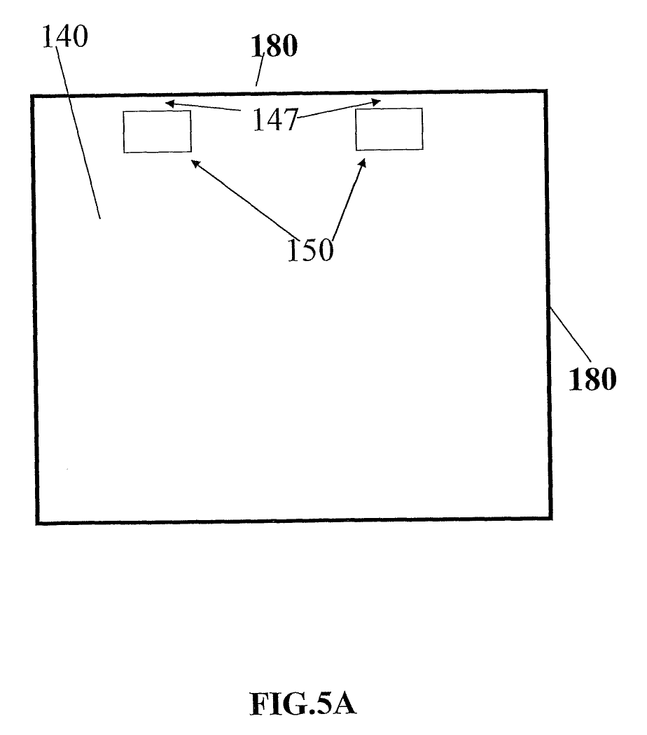

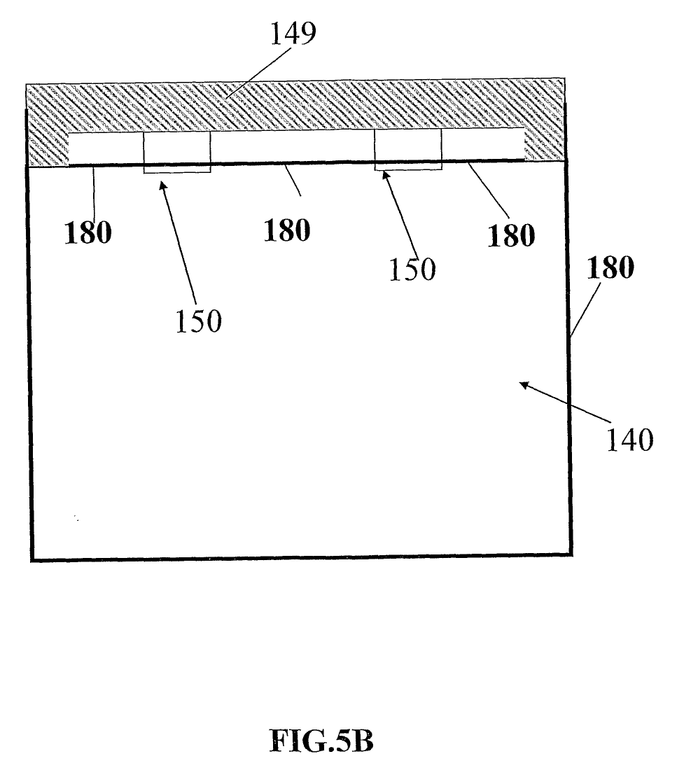

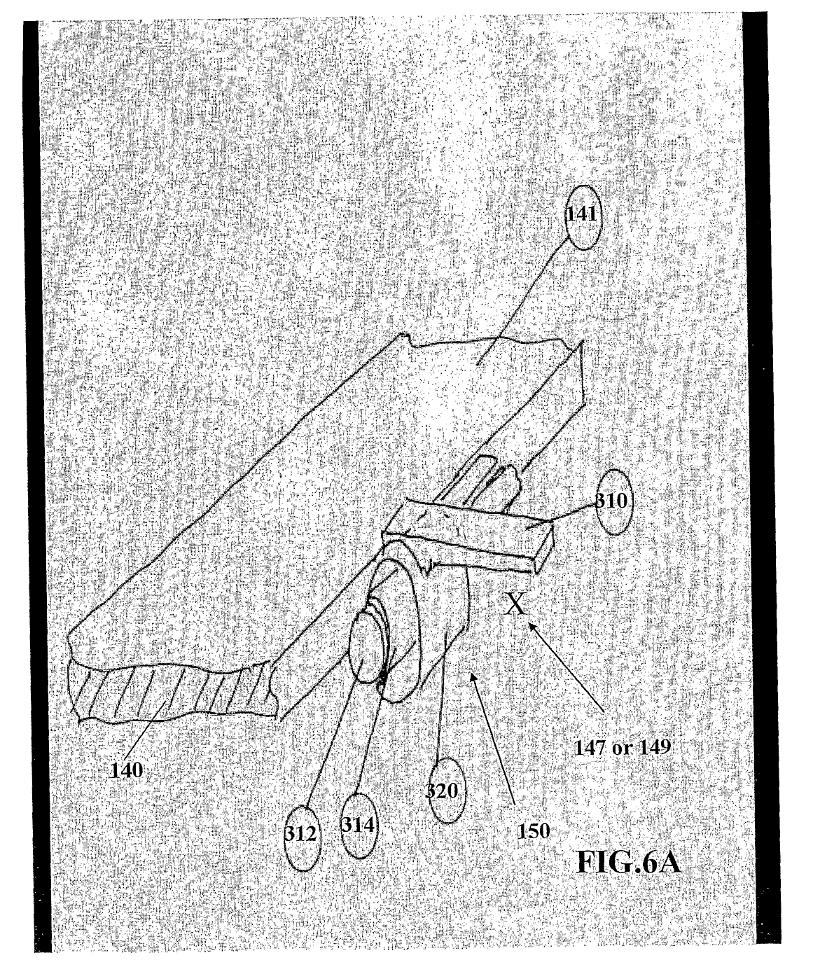

FIG. 5A provides a diagram of an embodiment where the receiver 150 is located near but not at the edge 180 of the board 140 (for example, within a few centimeters or less from the edge of the board 140). This may be provided, for example, by boring a hole either through the board 140 or partly through the board 140. Region 147 of board 140 is completely optional. Alternatively, as shown in FIG. 5B, the receiver 150 is mechanically supported by a optional separate support element 149, made of any material (including a material similar to the board), of any shape.

### Structure and Function

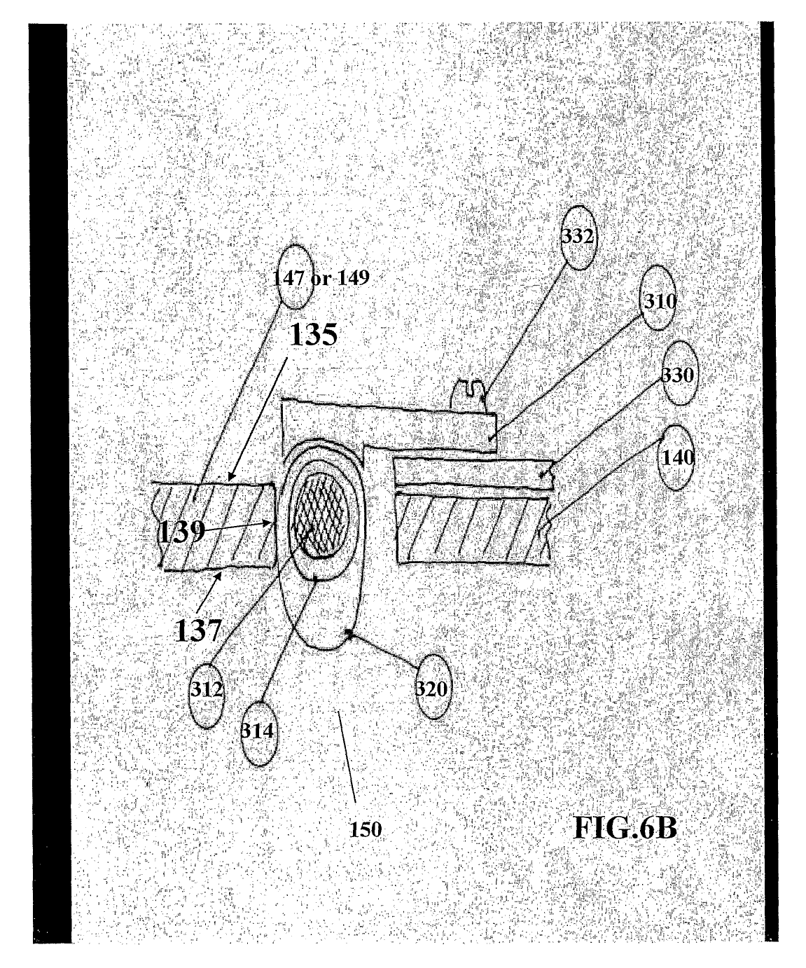

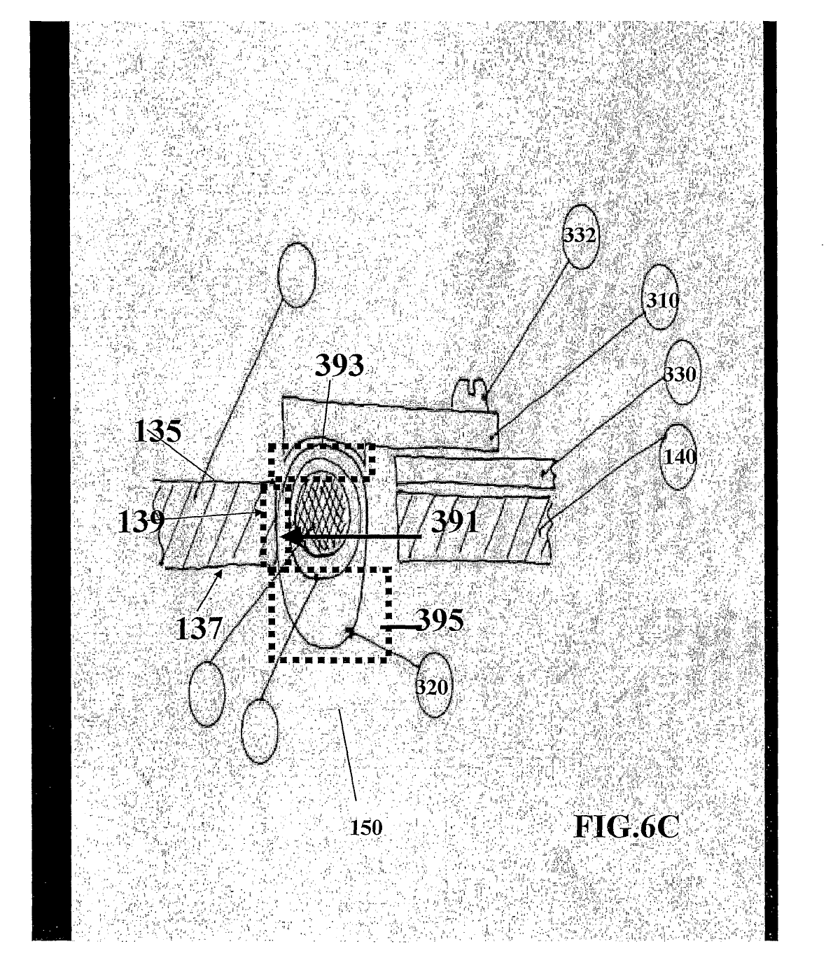

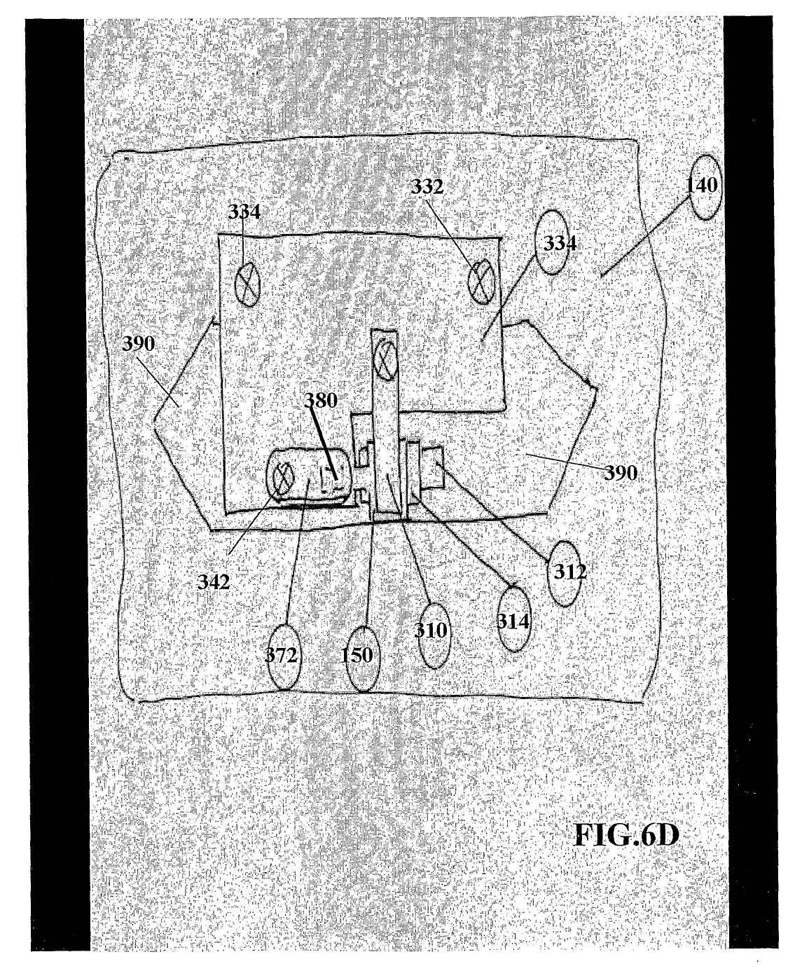

FIG. 6A present an illustration of an exemplary ultra-sound receiver 150 coupled to board 140. As shown in FIG. 6A, the ultra-sound receiver 150 includes a piezzo film 320 for detecting ultra-sound waver which propagates in or along the surface 141 of the writing board 140. The piezzo film 320 is operative to generate an electrical signal in accordance with detecting ultra-sound waves propagating in the board 140, thus “converting” the mechanical pressure wave into an electrical signal.

The piezzo film is fastened to the board by a fastener 310 (for example, a plastic fastener, or a fastener made from a material other than a conducting material such as an insulator) such that at least a portion of the piezzo film 320 is substantially below the plane and/or coplanar with the upper surface 141 of the writing board 140, though this is not a limitation. Within the rolled piezzo film 320, is an inner core 312 or cylinder (for example, for mechanical support and/or for improving the receiver's electrical performance). This core 312 may be made of any material, including but not limited to conducting materials (such as metals), semi-conductor materials, and insulators. In the case where a conducting material is selected, it may be recommended or necessary to provide an insulating layer 314 between the piezzo film 320 and the conducting core 312.

As illustrated in the FIG. 6A, in non-limiting exemplary embodiments, at least a portion of the piezzo film 320 is at a level of and/or below an upper surface 341 of the writing board 340.

FIG. 6B provides a side view of the ultra-sound receiver.

As shown in FIG. 6B, the receiver 150 further includes a mechanical fastener (for example, screw 332)_for attaching the fastener 310 to the writing board 140. Furthermore, a printed circuit board (PCB) 330 is provided. Typically, the PCB 330 is operative to receive electrical signals from the piezzo film 320, and to process and/or transmit these electrical signals. Although not illustrated explicitly in FIG. 6B, it is noted that typically the PCB is in electrical contact with both “terminals” (i.e. both sides) of the piezzo film 320.

As shown in FIGS. 6B-6C, at least a “contacting portion” 391 of piezoelectric film 320 is in contact with a “side surface” 139 of writing surface/board 140.

As shown in FIGS. 6B and/or 6C, the upper surface of writing surface/board 140 is numbered as 135; the side surface of writing surface/board 140 is numbered as 139; the lower surface of writing surface/board 140 is numbered as 137.

At least an “upper portion” 393 of piezoelectric film 320 is “above” upper surface 135; at least a “lower portion” 395 of piezoelectric film 320 is “below” lower surface 137.

According to the specific example of FIG. 6D, the PCB 330 is attached to the writing board 140, for example, using mechanical fasteners such as screws 334.

Although the illustrations refer to a PCB 330, it is noted that any ‘housing’ for electrical circuitry (chips in a single chip or multi-chip package) may be used.

FIG. 6D provides a top view of the ultra-sound receiver 150. It is noted that FIG. 6D refers to the embodiment depicted in FIG. 5A, though it is appreciated that the principles of FIG. 6D apply to the embodiment of FIG. 5B as well.

Thus, referring to FIG. 6D it is noted that the piezzo film 320 includes a terminal 380 (i.e. formed itself from piezzo film, for example, integrally formed with piezzo film 320) adapted to provide electrical contact with electrical circuitry residing on or in the PCB 330. This electrical contact may be provided, at least in part, with an elongated conducting member 372 for example fashioned of metal or another conductor (in our example, conducting member 372 is useful for transmitting an electrical signal from the “upper” surface 364 of the piezzo terminal 380) which is electrically connected to one side of the piezzo film 320 terminal 380. This conducting member 372 is fastened to the PCB 330, for example, using a fastener such as a mechanical fastener such as screw 342.

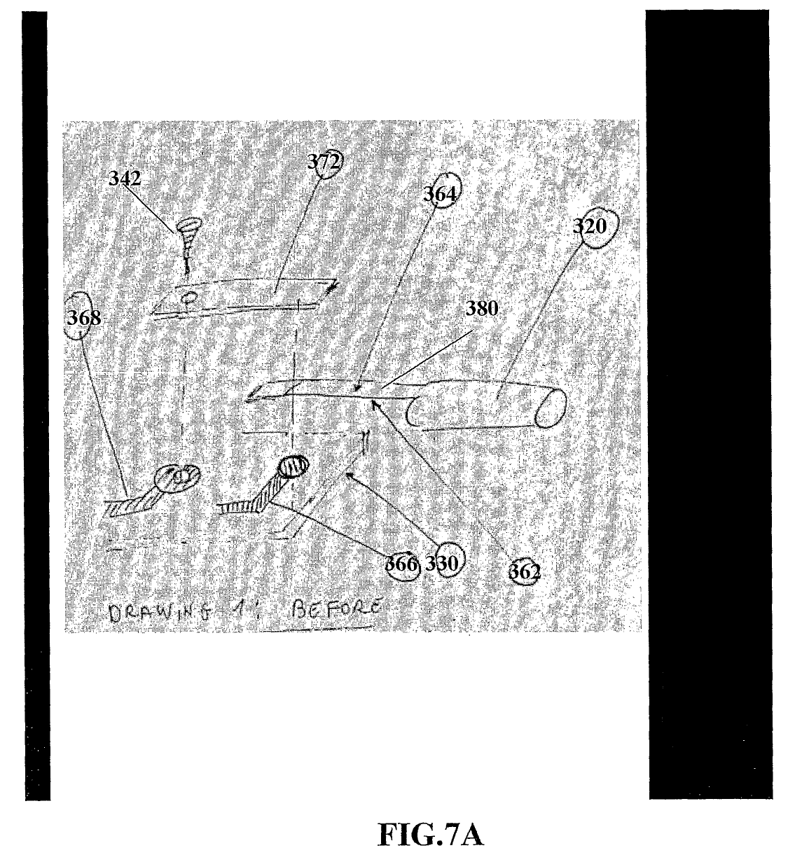

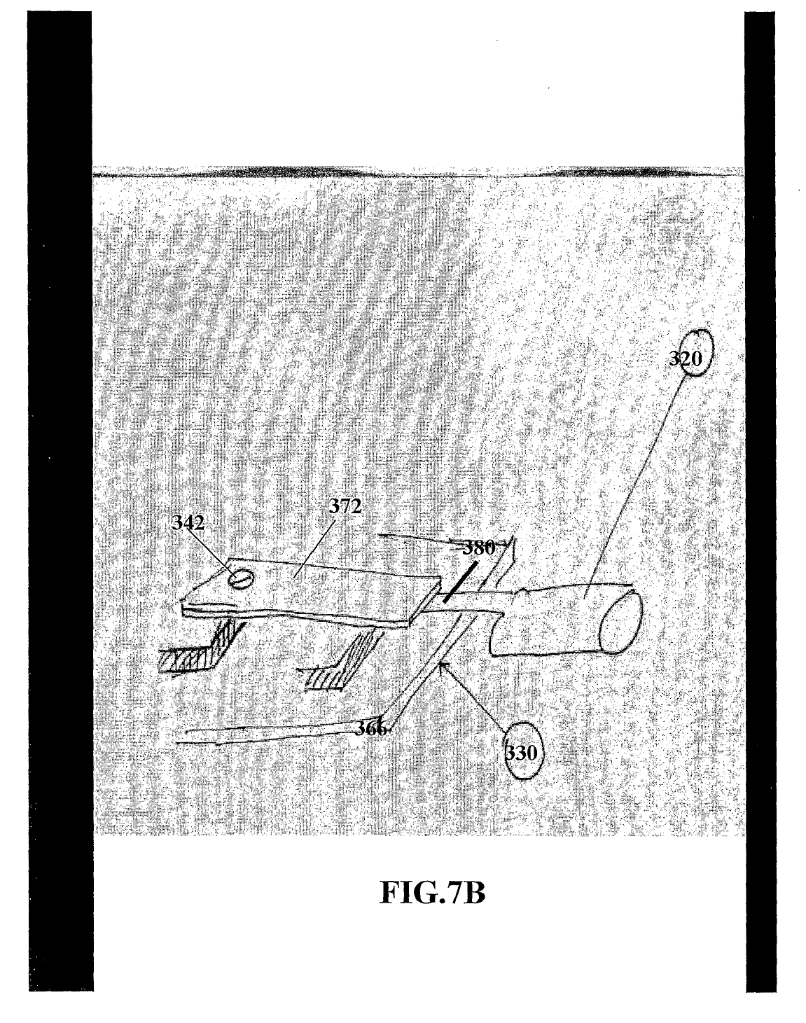

FIG. 7A provides an exploded view of attaching the terminal 380 of the piezzo film 320 to the PCB 330. It is noted that the terminal 380 of the piezzo film 320 has two surfaces, which are not in electrical contact with each other—namely, an upper surface 364 and a lower surface 362. Thus, as shown in FIG. 7B, the lower surface 362 is in contact with a first electrical conductor 366 (an attached and/or embedded object such as a wire, or a printed conducting region 366 printed on the PCB) of the PCB.

The upper surface 364 of the terminal 380 of the piezzo film 320 in electrical contact with (for example, attached to) a conductor (for example, elongated conductor 372). This elongated conducting piece 372 is typically not in electrical contact with the lower surface 362 of the terminal 380.

This elongated conducting piece 372 may be in electrical contact with a second printed conducting region 368 of the PCB. Thus, it evident that 366 and 368 may serve, effectively, as a pair of terminals for the piezzo film 320 (and as part of an “interface” between the piezzo film 320 which generates an electrical signal and external electrical circuitry, for example, on PCB 330, which handles the generated electrical signal) and that an electrical potential between these two terminal (i.e. 366 and 368) on the PCB (i.e. generated by the piezzo film 320) is therefore determined in accordance with acoustic or ultra-sound signals detected by the piezzo film 320. The signal is subsequently handled (for example, processed and used in triangulation to determine the location of stylus 100.

FIG. 7B provides another perspective of the electrical contacts between the piezzo film 320 and the PCB 330.

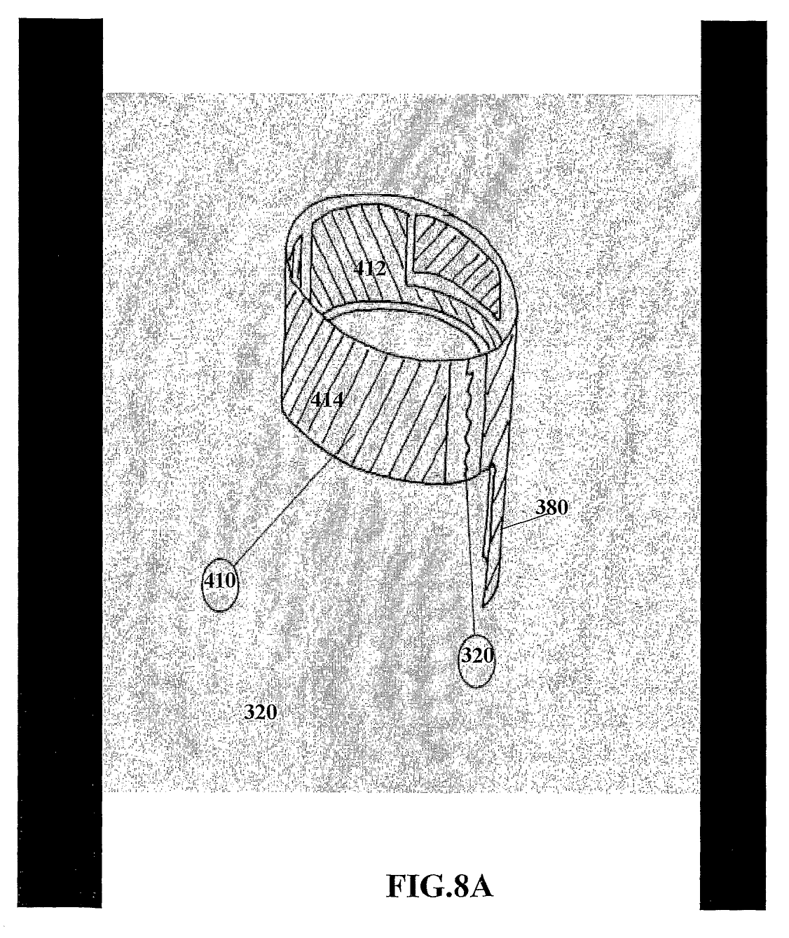

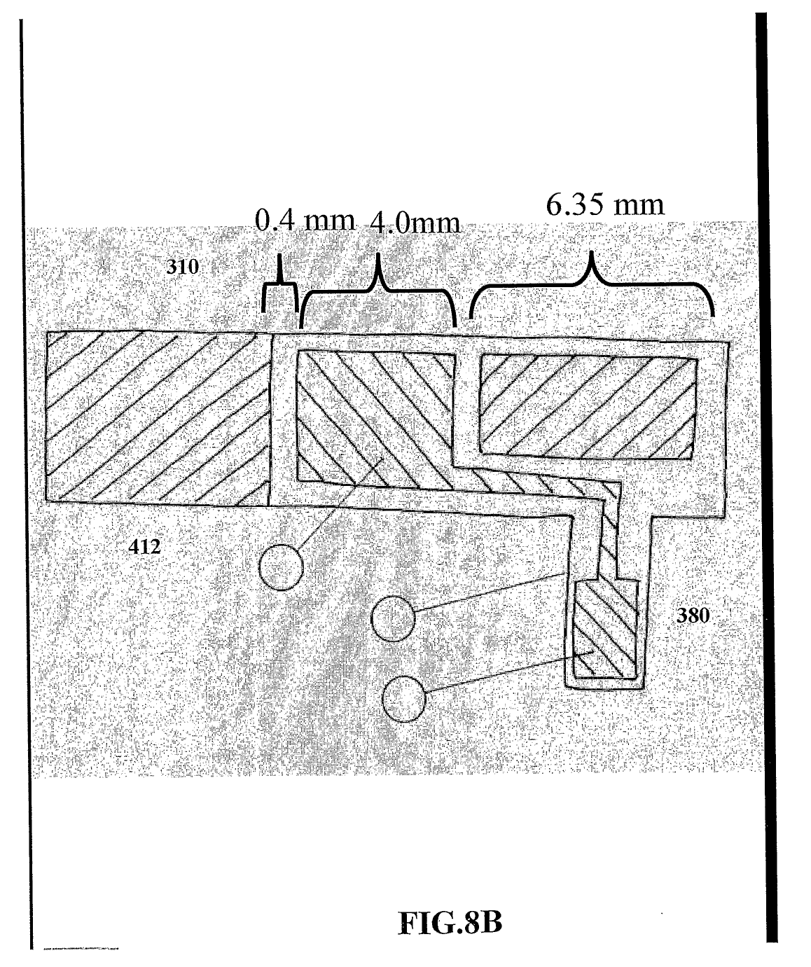

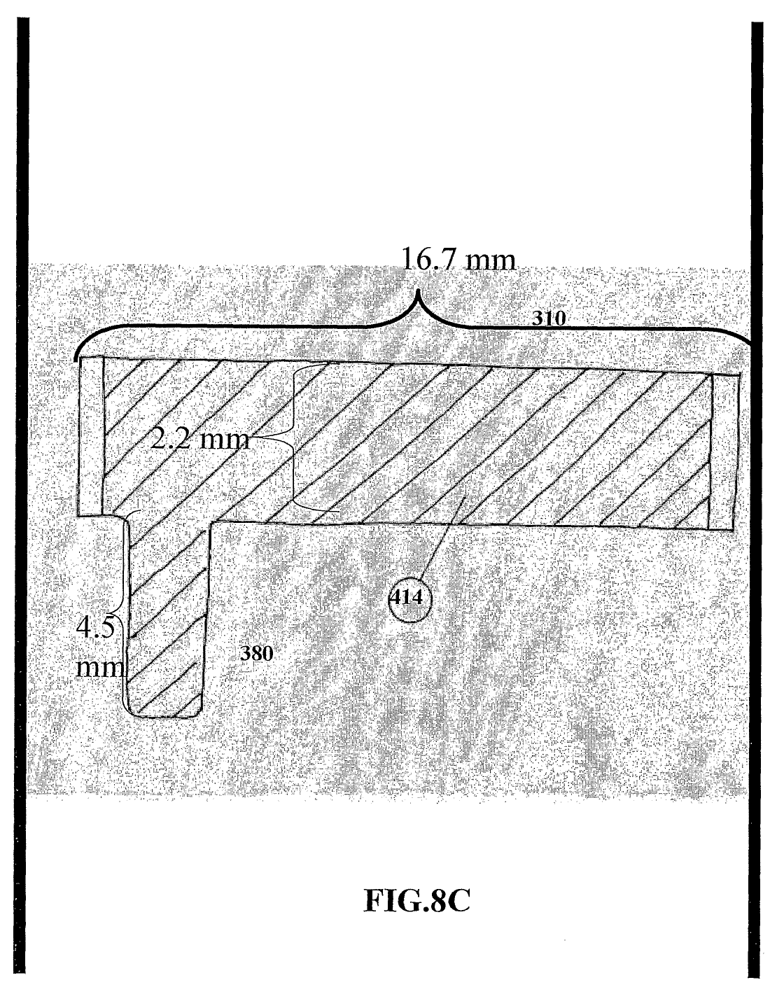

FIG. 8A provides another image of the piezzo film 320. Thus, as shown in FIG. 8A, the piezzo film includes a ‘main portion’ 410) of printed ink. When rolled up, at least a part of this main portion 410 defines a cylindrical shape. Typically, it is this ‘main portion’ 410 which detected the ultra-sound signal.

As shown in FIG. 8B, there is a wielding 320 or any other means of fastening the ends of the piezzo film 320 (i.e. the main portion 410) to create a single ‘continuous’ strip, but this is not a limitation, and it can be non-continuous.

The distances illustrated in FIGS. 8A-8C are for example purposes only, and are not a limitation.

As shown in FIGS. 8B and 8C, the structure ‘sensitive area’ on each side (i.e. the inner surface 412 and the outer surface 414) of the piezzo film 320 (for example, the structure of the deposited ink) is not identical. In the figures, the shaded regions denote the ‘sensitive area’.

It is noted that on one side of the piezzo film, the shaded regions are not contiguous to define specific regions which are each at a different voltage (relative to the other side of the piezzo film) when detecting ultra-sound signals.

It is note that in some embodiments, the inner 412 and outer surfaces 414 of the piezzo film 320 are structure according to one or more teachings disclosed in international patent application publication WO 03/022156 of the present inventors (for example, see FIGS. 4A-4B among others), incorporated herein by reference.

It is noted that in some embodiments, one or more teachings disclosed in international patent application publication WO 03/022156 (incorporated herein by reference) (i.e. which discloses an ultrasound transceiver and cylindrical ultrasound transducer structure) may be applied to any presently-disclosed ultra-sound receiver assembly, and any system or method disclosed

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

1-99. (canceled)

100) A contact-mode measuring system comprising:
a) a digital pen including a pen housing having a tip and a pen-fixed ultrasound device selected from the group consisting of an ultrasound transmitter and an ultrasound receiver;
b) a writing surface;
c) a plurality of writing-surface-fixed ultrasound devices, each said ultrasound device selected from the group consisting of an ultrasound transmitter and an ultrasound receiver, each writing-surface-fixed ultrasound device having a respective position that is fixed relative to said writing surface;
d) an ultra-sound propagation time measurement system operative, when said digital pen is located on said writing surface, to measure for said each writing-surface-fixed ultrasound device, a respective time that it takes for ultrasound to travel, through said writing surface, between:
(i) said pen-fixed ultrasound device; and
(ii) said each writing-surface-fixed ultrasound device, via a path that includes a respective writing subpath defined by a path between:
(i) a location that is substantially a contact location between said tip and said writing surface within a tolerance that is less than 30% a distance between said contact location and a closest said writing-surface fixed ultrasound device; and
(ii) said each writing-surface-fixed device; and
e) an ultra-sound based position-determining system for determining a position of said pen-fixed ultrasound device in accordance with:
i) said determined ultra-sound travel times; and
ii) a speed of sound within said writing surface.

101) The system of claim 100 further comprising:
e) a hover-detection element operative to determine if said digital pen is in contact with said writing surface or hovering above said writing surface in accordance with a magnitude of detected sound signals between said pen-fixed ultrasound transceiver and at least one said writing-surface-fixed ultrasound transceiver.

102) The system of claim 100 wherein said writing surface includes an edge having a jagged section wherein:
i) the length of said jagged section is at least 0.2 times the longest dimension of said writing surface;
ii) said jagged edge includes at least n peaks and n−1 troughs, n being defined as an integer that is at least 5;
iii) for adjacent peaks over said edge, a distance between adjacent peaks is between at least 0.01 and at most 0.1 times said longest dimension of said writing surface; and
iv) for each peak, a peak-to-adjacent trough distance is at least 0.001 and at most 0.03 times said longest dimension of said writing surface.

103) The system of claim 100 further comprising:
f) a wired connection between said pen-fixed ultrasound transceiver and each said writing-surface-fixed ultrasound transceiver for ultra-sound signal synchronization,
wherein said ultra-sound propagation time measurement system is operative to measure said sound travel times in accordance with said wired-connection-provided signal synchronization.

104) The system of claim 100 wherein:
i) said digital pen further includes an optical transmitter operative to transmit light downwards;
ii) the system further includes a writing surface fixed optical receiver; and
iii) said writing surface is configured as a waveguide to substantially control a direction of propagation of light such that said propagating light is forced to follow a path that is substantially, within a tolerance of at most 10 degrees, parallel to a plane defined by an upper surface of writing surface for a distance that is at least 20% a distance between optical transmitter and optical receiver.

105) A contact or hovering mode position measuring system comprising:
a) a digital pen including a pen housing having a tip and a pen-fixed ultrasound device selected from the group consisting of an ultrasound transmitter and an ultrasound receiver;
b) a writing surface;
c) a plurality of writing-surface-fixed ultrasound devices, each said ultrasound device selected from the group consisting of an ultrasound transmitter and an ultrasound receiver, each writing-surface-fixed ultrasound device having a respective position that is fixed relative to said writing surface;
d) an ultra-sound propagation time measurement system operative, when said digital pen is located on or over said writing surface, to measure for said each writing-surface-fixed ultrasound device, a respective time that it takes for ultrasound to travel, through said writing surface, between:
(i) said pen-fixed ultrasound device; and
(ii) said each writing-surface-fixed ultrasound device, via a path that includes a respective writing surface subpath defined by a path between:
(i) an intersection point between elongate axis of said ultrasound device and said writing surface within a tolerance that is less than 30% a distance between said tip and a closest said writing-surface fixed ultrasound device; and
(ii) said each writing-surface-fixed device;
e) an ultra-sound based position-determining system for determining a position of said pen-fixed ultrasound device in accordance with:
i) said determined ultra-sound travel times; and
ii) a speed of sound within said writing surface.

106) The system of claim 105 further comprising:
e) a hover-detection element operative to determine if said digital pen is in contact with said writing surface or hovering above said writing surface in accordance with a magnitude of detected sound signals between said pen-fixed ultrasound transceiver and at least one said writing-surface-fixed ultrasound transceiver.

107) The system of claim 105 wherein said writing surface includes an edge having a jagged section wherein:
i) the length of said jagged section is at least 0.2 times the longest dimension of said writing surface;
ii) said jagged edge includes at least n peaks and n−1 troughs, n being defined as an integer that is at least 5;
iii) for adjacent peaks over said edge, a distance between adjacent peaks is between at least 0.01 and at most 0.1 times said longest dimension of said writing surface; and
iv) for each peak, a peak-to-adjacent trough distance is at least 0.001 and at most 0.03 times said longest dimension of said writing surface.

108) The system of claim 105 further comprising:
f) a wired connection between said pen-fixed ultrasound transceiver and each said writing-surface-fixed ultrasound transceiver for ultra-sound signal synchronization,
wherein said ultra-sound propagation time measurement system is operative to measure said sound travel times in accordance with said wired-connection-provided signal synchronization.

109) The system of claim 105 wherein:
i) said digital pen further includes an optical transmitter operative to transmit light downwards;
ii) the system further includes a writing surface fixed optical receiver; and
iii) said writing surface is configured as a waveguide to substantially control a direction of propagation of light such that said propagating light is forced to follow a path that is substantially, within a tolerance of at most 10 degrees, parallel to a plane defined by an upper surface of writing surface for a distance that is at least 20% a distance between optical transmitter and optical receiver.

110) A position measuring system comprising:
a) a digital pen including a pen housing having a tip and a pen-fixed ultrasound device selected from the group consisting of an ultrasound transmitter and an ultrasound receiver;
b) a writing surface;
c) a plurality of writing-surface-fixed ultrasound devices, each said ultrasound device selected from the group consisting of an ultrasound transmitter and an ultrasound receiver, each writing-surface-fixed ultrasound device having a respective position that is fixed relative to said writing surface;
d) an ultra-sound propagation time measurement system operative, when said digital pen is located on or over said writing surface, to measure for said each writing-surface-fixed ultrasound device, a respective time that it takes for ultrasound to travel, through said writing surface, between:
(i) said pen-fixed ultrasound device; and
(ii) said each writing-surface-fixed ultrasound device, via a path that includes a respective writing surface subpath selected from the group consisting of
A) a first respective writing surface subpath defined by a path between:
I) a given point whose distance from, an intersection point between elongate axis of said ultrasound receiver and said writing surface, is less than 30% a distance between said tip and a closest said writing-surface fixed ultrasound device; and
II) said each writing-surface-fixed device;
B) a second respective writing surface subpath defined by a path between:
I) a location that is substantially a contact location between said tip and said writing surface within a tolerance that is less than 30% a distance between said contact location and a closest said writing-surface fixed ultrasound device; and
II) said each writing-surface-fixed device; and
e) an ultra-sound based position-determining system for determining a position of pen-fixed ultrasound device in accordance with:
i) said determined ultra-sound travel times; and
ii) a speed of sound within said writing surface.

111) The system of claim 110 further comprising:
e) a hover-detection element operative to determine if said digital pen is in contact with said writing surface or hovering above said writing surface in accordance with a magnitude of detected sound signals between said pen-fixed ultrasound transceiver and at least one said writing-surface-fixed ultrasound transceiver.

112) The system of claim 110 wherein said writing surface includes an edge having a jagged section wherein:
i) the length of said jagged section is at least 0.2 times the longest dimension of said writing surface;
ii) said jagged edge includes at least n peaks and n−1 troughs, n being defined as an integer that is at least 5;
iii) for adjacent peaks over said edge, a distance between adjacent peaks is between at least 0.01 and at most 0.1 times said longest dimension of said writing surface; and
iv) for each peak, a peak-to-adjacent trough distance is at least 0.001 and at most 0.03 times said longest dimension of said writing surface.

113) The system of claim 110 further comprising:
f) a wired connection between said pen-fixed ultrasound transceiver and each said writing-surface-fixed ultrasound transceiver for ultra-sound signal synchronization,
wherein said ultra-sound propagation time measurement system is operative to measure said sound travel times in accordance with said wired-connection-provided signal synchronization.

114) The system of claim 110 wherein:
i) said digital pen further includes an optical transmitter operative to transmit light downwards;
ii) the system further includes a writing surface fixed optical receiver; and
iii) said writing surface is configured as a waveguide to substantially control a direction of propagation of light such that said propagating light is forced to follow a path that is substantially, within a tolerance of at most 10 degrees, parallel to a plane defined by an upper surface of writing surface for a distance that is at least 20% a distance between optical transmitter and optical receiver.

115) An electronic pen device comprising:
a) an elongated housing including an elongated inner cavity and a tip; and
b) an ultrasound transmitter for generating ultrasound waves, comprising a piezoelectric film cylinder deployed within said elongated inner cavity such that an elongate axis of said piezoelectric film cylinder is substantially parallel to an elongate axis of said elongated inner cavity within a tolerance that is at most 45 degrees.

116) The pen device of claim 115 further comprising:
c) at least one ultrasound reflector deployed above said piezoelectric film cylinder within said elongated inner cavity for reflecting upwardly propagating sound generated by said ultrasound transmitter relative to a body-fixed axis of the pen device in a downwards direction, said at least one ultrasound reflector operative to downwardly reflect at least a 25% by ultrasound power upwardly propagating, relative to said body-fixed axis, said ultrasound generated by ultrasound transmitter.

117) A system for handling ultrasound signals, the system comprising:
a) a thin writing surface having a thickness that is at most 0.05 times a longest dimension of said writing surface; and
b) an ultrasound receiver comprising a piezoelectric film cylinder fixed relative to said writing surface, at least a contacting portion of said piezoelectric film cylinder deployed in contact with said side surface of said thin writing surface, at least an upper portion of said piezoelectric film cylinder deployed above an upper surface of said writing surface, at least a lower portion of said piezoelectric film deployed below a lower surface of said writing surface, said ultrasound receiver configured to receive ultrasound signals that propagate within said writing surface.
